(19) United States
(12) Patent Application Publication
(10) Pub. No.: US 2025/0198707 A1
(43) Pub. Date: Jun. 19, 2025

(54) THERMAL ENERGY STORAGE TANK

(71) Applicants: TOSHIBA ENERGY SYSTEMS & SOLUTIONS CORPORATION, Kawasaki-shi (JP); Chubu Electric Power Company, Incorporated, Nagoya-shi (JP)

(72) Inventors: Masayuki SATO, Yokohama Kanagawa (JP); Koichi GOTO, Yokohama Kanagawa (JP); Chikako IWAKI, Shinagawa Tokyo (JP); Masato FUKUTA, Ota Tokyo (JP); Takashi MAWATARI, Kawasaki Kanagawa (JP); Osamu FURUYA, Kawasaki Kanagawa (JP); Hiromutsu MIKI, Yokohama Kanagawa (JP); Naoya MATSUDA, Nagoya Aichi (JP); Norio OIWA, Nagoya Aichi (JP)

(73) Assignees: TOSHIBA ENERGY SYSTEMS & SOLUTIONS CORPORATION, Kawasaki-shi (JP); Chubu Electric Power Company, Incorporated, Nagoya-shi (JP)

(21) Appl. No.: 18/968,128

(22) Filed: Dec. 4, 2024

(30) Foreign Application Priority Data
Dec. 14, 2023 (JP) 2023-211508

(51) Int. Cl. F28D 20/00

(52) U.S. Cl. CPC F28D 20/0056

(57) ABSTRACT

A thermal energy storage tank of one embodiment is a thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation. In addition, the first solid sensible heat storage material is incorporated into a first area that is nearest to an outlet or an inlet of the fluid during the thermal energy storage operation. Furthermore, the first solid sensible heat storage material has a smaller particle size than the n-th solid sensible heat storage material.

### CROSS REFERENCE TO RELATED APPLICATION

This application is based upon and claims the benefit of priority from the prior Japanese Patent Application No. 2023-211508, filed on Dec. 14, 2023, the entire contents of which are incorporated herein by reference.

### FIELD

Embodiments disclosed herein relate to a thermal energy storage tank.

### BACKGROUND

In recent years, power generation from renewable energy such as solar power generation and wind power generation has been increasing, and depending on the season and time of day, there are regions where an amount of power generated is greater than a demand for power. In addition, the demand for power may increase during certain seasons and times of the day, in which case the amount of power generated may not meet the demand for power and may cause a power shortage. A conventional technique that uses thermal energy storage to implement power conditioning will now be described with reference to FIGS. 18 to 20.

FIG. 18 is an overall configuration diagram of a power conditioning system 100 including a thermal energy storage system 200 according to the conventional technique.

The power conditioning system 100 including the thermal energy storage system 200 according to the conventional technique is equipped with a thermal energy storage tank 1, an electric heater 2, a first blower 3, a second blower 4, a condensate pump 8, a boiler 9, a steam turbine 10, a condenser 11 and a plurality of valves 12 to 15. The thermal energy storage system 200 is equipped with the thermal energy storage tank 1, the electric heater 2, the first blower 3, the second blower 4, the valves 12 to 15, and the boiler 9 that is a thermal supply destination. FIG. 18 further shows air 5, water 6, and steam 7 that circulate inside the power conditioning system 100 including the thermal energy storage system 200.

When there is excess power, the power conditioning system 100 including the thermal energy storage system 200 stops the condensate pump 8, the steam turbine 10, and the second blower 4, opens the valves 12 and 13 and closes the valves 14 and 15, and uses the excess power to operate the electric heater 2 and the first blower 3. In addition, the thermal energy storage system 200 uses the first blower 3 to circulate the air 5 between the electric heater 2 and the thermal energy storage tank 1. The air 5 is heated by heat generated by the electric heater 2, transports the heat to the thermal energy storage tank 1, and heats a thermal energy storage substance inside the thermal energy storage tank 1. The thermal energy storage substance is a solid sensible heat storage material 23 that is, for example, a rock. The solid sensible heat storage material 23 absorbs heat held by all or part of the air 5 and, accordingly, heat is stored in the thermal energy storage tank 1.

FIG. 19 is a schematic view and a diagram showing a temperature distribution during a thermal energy storage operation of the thermal energy storage tank 1 according to the conventional technique.

An upper half of FIG. 19 shows a schematic view of the thermal energy storage tank 1 during a thermal energy storage operation according to the conventional technique. As the thermal energy storage tank 1, a thermal energy storage tank that is long in a flow direction is often arranged horizontally. A solid arrow in the thermal energy storage tank 1 denotes an air flow direction 32 during a thermal energy storage operation.

When there is no excess power, the power conditioning system 100 including the thermal energy storage system 200 stops the electric heater 2 and the first blower 3, closes the valves 12 and 13 and opens the valves 14 and 15, and operates the condensate pump 8 and the second blower 4. In addition, the power conditioning system 100 including the thermal energy storage system 200 uses the second blower 4 to circulate the air 5 between the thermal energy storage tank 1 and the boiler 9. The air 5 is heated by the thermal energy storage substance in the thermal energy storage tank 1 and transports the heat to the boiler 9. The solid sensible heat storage material 23 dissipates retained heat by having the air 5 absorb the heat. The boiler 9 heats water carried in by the condensate pump 8 with heat from the air 5 and produces steam while a temperature of the air 5 drops and the air 5 flows out. A thermal dissipation operation is carried out in this manner. By flowing inside the steam turbine 10 at a low temperature and low pressure, the steam 7 rotates and drives the steam turbine 10 that is an impeller and a power generator (not illustrated) mechanically connected to the steam turbine 10 generates power. The steam discharged from the steam turbine 10 is cooled by cooling water such as seawater in the condenser 11 and changes to water to be circulated. Accordingly, steam is generated by heat stored in the thermal energy storage substance in the thermal energy storage tank 1 and power is generated. Accordingly, power conditioning is implemented by using power when there is excess power and by generating power when there is no excess power.

During a thermal energy storage operation, the thermal energy storage tank 1 forms a first thermocline 26 that indicates a steep temperature gradient in the flow direction, the first thermocline 26 moves from an upstream side to a downstream side during the thermal energy storage operation, and the thermal energy storage operation ends once the temperature of the air 5 flowing out from the thermal energy storage tank 1 rises to a thermal energy storage operation-time allowable temperature 28.

A lower half of FIG. 19 shows a temperature distribution diagram during a thermal energy storage operation of the thermal energy storage tank 1 according to the conventional technique. An axis of abscissa indicates a position in the thermal energy storage tank 1 and an axis of ordinate indicates a thermal energy storage temperature of the solid sensible heat storage material 23. A first thermal energy storage temperature 24 is lower than the air 5. In other words, there is a temperature difference between an inflow air temperature 50 that is a temperature of the air 5 flowing into the thermal energy storage tank 1 during a thermal energy storage operation and the first thermal energy storage temperature 24. The first thermocline 26 moves over time and becomes a second thermocline 27. A temperature of outlet air that is air at an outlet of the thermal energy storage tank 1 rises and reaches the thermal energy storage operation-time allowable temperature 28 of the thermal energy storage system 200 during the second thermocline 27, at which time the thermal energy storage operation ends. The thermal energy storage operation-time allowable temperature 28 is, for example, a heat-resistance temperature of a valve (in FIG. 18, the valve 13) or a blower (in FIG. 18, the first blower 3) installed downstream of the thermal energy storage tank 1. A thermal energy storage amount in the thermal energy storage tank 1 is desirably increased.

FIG. 20 is a schematic view and a diagram showing a temperature distribution during a thermal dissipation operation of the thermal energy storage tank 1 according to the conventional technique.

An upper half of FIG. 20 shows a schematic view of the thermal energy storage tank 1 according to the conventional technique. A solid arrow in the thermal energy storage tank 1 denotes an air flow direction 33 during a thermal dissipation operation.

During the thermal dissipation operation, the thermal energy storage tank 1 forms a third thermocline 29 that indicates a steep temperature gradient in the flow direction, the third thermocline 29 moves from an upstream side to a downstream side during the thermal dissipation operation, and the thermal dissipation operation ends once the temperature of the air 5 flowing out from the thermal energy storage tank 1 drops to a thermal dissipation operation-time allowable temperature 31.

A lower half of FIG. 20 shows a temperature distribution diagram during a thermal dissipation operation of the thermal energy storage tank 1 according to the conventional technique. A temperature of outflow air drops below a temperature of the solid sensible heat storage material 23. In other words, there is a temperature difference between a first outflow air temperature 25 that is a temperature of the air 5 flowing out from the thermal energy storage tank 1 according to the conventional technique during a thermal dissipation operation and the first thermal energy storage temperature 24. The third thermocline 29 moves over time and becomes a fourth thermocline 30. The first outflow air temperature 25 drops and reaches the thermal dissipation operation-time allowable temperature 31 of the thermal energy storage system 200 during the fourth thermocline 30, at which point the thermal dissipation operation ends. The thermal dissipation operation-time allowable temperature 31 is, for example, an allowable temperature on a heat demand side such as a minimum temperature required to operate the boiler 9. In the thermal energy storage tank 1, desirably, a thermal energy storage amount is increased, a thermal dissipation temperature is raised, a thermal dissipation operation time is extended, and a thermal dissipation amount is increased.

### BRIEF DESCRIPTION OF THE DRAWINGS

FIG. 1 is a schematic view and a diagram showing a temperature distribution during a thermal energy storage operation of a thermal energy storage tank 1 according to a first embodiment;

FIG. 2 is a schematic view and a diagram showing a temperature distribution during a thermal energy storage operation of the thermal energy storage tank 1 according to a second embodiment;

FIG. 3 is a schematic view of a thermal energy storage tank according to a third embodiment;

FIGS. 4A to 4B are schematic views during a thermal energy storage operation of the thermal energy storage tank 1 according to a fourth embodiment;

FIGS. 5A to 5B are schematic views during a thermal dissipation operation of the thermal energy storage tank 1 according to the fourth embodiment;

FIGS. 6A to 6C are schematic views during a thermal energy storage operation of the thermal energy storage tank 1 according to a fifth embodiment;

FIGS. 7A to 7C are schematic views during a thermal dissipation operation of the thermal energy storage tank 1 according to the fifth embodiment;

FIG. 8 is a schematic view and a diagram showing a temperature distribution during a thermal energy storage operation of the thermal energy storage tank 1 according to a sixth embodiment;

FIG. 9 is a schematic view and a diagram showing a temperature distribution during a thermal energy storage operation of the thermal energy storage tank 1 according to a seventh embodiment;

FIG. 10 is a schematic view and a diagram showing a temperature distribution during a thermal dissipation operation of the thermal energy storage tank 1 according to the seventh embodiment;

FIG. 11 is a schematic view and a diagram showing a temperature distribution during a thermal dissipation operation of the thermal energy storage tank 1 according to an eighth embodiment;

FIG. 12 is a schematic view of a thermal energy storage tank according to a ninth embodiment;

FIGS. 13A to 13B are schematic views during a thermal energy storage operation of the thermal energy storage tank 1 according to a tenth embodiment;

FIGS. 14A to 14B are schematic views during a thermal dissipation operation of the thermal energy storage tank 1 according to the tenth embodiment;

FIGS. 15A to 15C are schematic views during a thermal energy storage operation of the thermal energy storage tank 1 according to an eleventh embodiment;

FIGS. 16A to 16C are schematic views during a thermal dissipation operation of the thermal energy storage tank 1 according to the eleventh embodiment;

FIG. 17 is a schematic view and a diagram showing a temperature distribution during a thermal dissipation operation of the thermal energy storage tank 1 according to a twelfth embodiment;

FIG. 18 is an overall configuration diagram of a power conditioning system 100 including a thermal energy storage system 200 according to a conventional technique;

FIG. 19 is a schematic view and a diagram showing a temperature distribution during a thermal energy storage operation of the thermal energy storage tank 1 according to the conventional technique; and

FIG. 20 is a schematic view and a diagram showing a temperature distribution during a thermal dissipation operation of the thermal energy storage tank 1 according to the conventional technique.

### DETAILED DESCRIPTION

Embodiments will now be explained with reference to the accompanying drawings. The embodiments are not intended to limit the present invention. The drawings are schematic or conceptual in nature and ratios of respective portions and the like are not necessarily the same as actual values thereof. In the specification and the drawings, elements similar to those having been already described with respect to existing drawings will be denoted by same reference signs and detailed descriptions will not be repeated when appropriate.

A thermal energy storage tank of one embodiment is a thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation. In addition, the first solid sensible heat storage material is incorporated into a first area that is nearest to an outlet or an inlet of the fluid during the thermal energy storage operation. Furthermore, the first solid sensible heat storage material has a smaller particle size than the n-th solid sensible heat storage material.

### First Embodiment

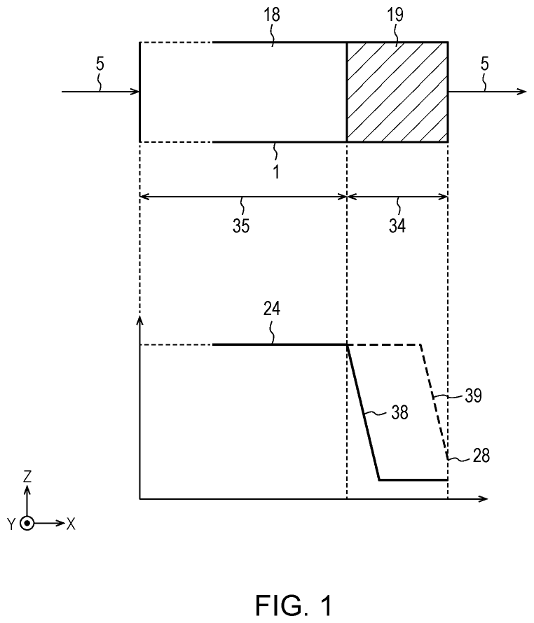

A first embodiment that corresponds to claims 1, 2, and 9 will be described. FIG. 1 is a schematic view and a diagram showing a temperature distribution during a thermal energy storage operation of a thermal energy storage tank 1 according to the first embodiment.

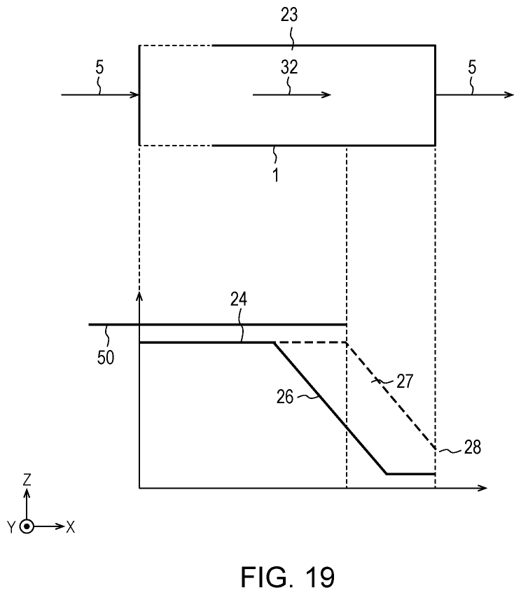

FIG. 1 shows an X axis, a Y axis, and a Z axis which are perpendicular to one another. An X direction and a Y direction correspond to crosswise directions (horizontal directions) that are perpendicular to the direction of gravitational force and a Z direction corresponds to a longitudinal direction (vertical direction) that is parallel to the direction of gravitational force. In addition, a +Z direction corresponds to an upward direction and a-Z direction corresponds to a downward direction. FIG. 19 according to the conventional technique corresponds to FIG. 1 according to the present embodiment.

In addition, while the thermal energy storage tank 1 uses the air 5 as a high-temperature heat source fluid in this example, another gas may be used or a liquid may be used instead of a gas. The air 5 is an example of a fluid that is a thermal medium.

While the air 5 only flows in +X directions during a thermal energy storage operation and a thermal dissipation operation in the embodiment described below, the air 5 in the thermal energy storage tank 1 is not limited to flowing in the +X directions and may also flow in the +Y directions and the +Z directions as long as the air 5 mainly flows in the +X directions. For example, the air 5 need only have a sufficient velocity component in the X direction even if there is a velocity component in the Y direction or a velocity component in the Z direction in the solid sensible heat storage material 23 in the thermal energy storage tank 1. A flow of the air 5 in such an aspect is also included in the flow of the air 5 in the X direction.

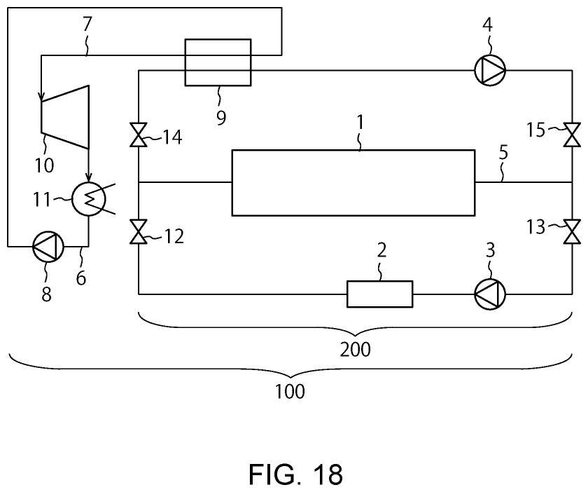

Since an overall configuration diagram of the power conditioning system 100 including the thermal energy storage system 200 is similar to FIG. 18, a description thereof will not be repeated. An upper half of FIG. 1 shows a schematic view of the thermal energy storage tank 1 during a thermal energy storage operation and a lower half of FIG. 1 shows a temperature distribution of the thermal energy storage tank 1 during the thermal energy storage operation and temperatures at corresponding positions in the schematic view in the upper half.

Unlike in the conventional technique, the thermal energy storage tank 1 in FIG. 1 incorporates a plurality of types of solid sensible heat storage materials 23. While an example in which the thermal energy storage tank 1 includes two mutually different types of solid sensible heat storage materials 23 will be described in the present embodiment, the number of types of solid sensible heat storage materials 23 included in the thermal energy storage tank 1 is not limited thereto. The thermal energy storage tank 1 may include any n-number of types (where n is an integer greater than or equal to 2) of solid sensible heat storage materials 23.

In the present embodiment, the two mutually different types of solid sensible heat storage materials 23 will be referred to as a first solid sensible heat storage material 19 and a second solid sensible heat storage material 18. In addition, an area of the thermal energy storage tank 1 in which the first solid sensible heat storage material 19 is incorporated will be referred to as a first area 34 and an area in which the second solid sensible heat storage material 18 is incorporated will be referred to as a second area 35. As described above, the thermal energy storage tank 1 may include any n-number of types of solid sensible heat storage materials 23, in which case an n-th type of solid sensible heat storage material will be referred to as an n-th solid sensible heat storage material and an area of the thermal energy storage tank 1 in which the n-th solid sensible heat storage material is incorporated will be referred to as an n-th area.

In the present embodiment, the first solid sensible heat storage material 19 is incorporated nearest to an outlet side of the thermal energy storage tank 1 from which the air 5 flows out during a thermal energy storage operation. The second solid sensible heat storage material 18 is incorporated on an upstream side of the air 5 during the thermal energy storage operation than the first solid sensible heat storage material 19. In other words, in the thermal energy storage tank 1, the first area 34 becomes an area nearest to the outlet of the air 5 during the thermal energy storage operation and the second area 35 becomes an area on an upstream side of the first area 34.

The thermal energy storage tank 1 according to the present embodiment stores heat by causing heat to be absorbed by the first solid sensible heat storage material 19 and the second solid sensible heat storage material 18 from the air 5 during a thermal energy storage operation and dissipates heat by causing heat held by the first solid sensible heat storage material 19 and the second solid sensible heat storage material 18 to be absorbed by the air 5 during a thermal dissipation operation.

In addition, in the present embodiment, the first solid sensible heat storage material 19 is a thermal energy storage material with a smaller particle size than the second solid sensible heat storage material 18. Furthermore, when the thermal energy storage tank 1 includes n-number of types of solid sensible heat storage materials 23, the first solid sensible heat storage material 19 is a thermal energy storage material with a smaller particle size than an n-th solid sensible heat storage material arranged on an upstream side during a thermal energy storage operation.

For example, rocks are used as the first solid sensible heat storage material 19 and the second solid sensible heat storage material 18. The first solid sensible heat storage material 19 and the second solid sensible heat storage material 18 are desirably the same thermal energy storage material or thermal energy storage materials with similar physical properties.

A partition is provided between the first solid sensible heat storage material 19 and the second solid sensible heat storage material 18 by a mesh-like member such as a wire mesh or other members that allow the air 5 to pass through during a thermal energy storage operation and a thermal dissipation operation.

Since the first solid sensible heat storage material 19 has a small particle size, a surface area per volume is larger as compared to the second solid sensible heat storage material 18. In addition, the first solid sensible heat storage material 19 has a larger sum of surface areas per volume of an incorporated area of a solid sensible heat storage material than the second solid sensible heat storage material 18. Therefore, compared to the second solid sensible heat storage material 18, the first solid sensible heat storage material 19 has a larger contact surface area with high-temperature air during a thermal energy storage operation, more readily transfers heat, and absorbs more heat. Therefore, a temperature drop of the air 5 is greater.

While a thermocline when outlet air reaches the thermal energy storage operation-time allowable temperature 28 during a thermal energy storage operation in the conventional technique is a second thermocline 27, a thermocline in the present embodiment at that point is a seventh thermocline 38. Since the first solid sensible heat storage material 19 more readily transfers heat and has a steeper thermocline than the second solid sensible heat storage material 18, the seventh thermocline 38 is formed on the inlet side of the thermal energy storage tank 1 than the second thermocline 27. Therefore, the outlet air has not reached the thermal energy storage operation-time allowable temperature 28 and the thermal energy storage operation can be continued. In the present embodiment, while the outlet air reaches the thermal energy storage operation-time allowable temperature 28 after the thermal energy storage tank 1 continues the thermal energy storage operation, the thermocline at that point is an eighth thermocline 39. Comparing a temperature profile being a relationship between elapsed time and a temperature in the thermal energy storage tank 1 with respect to FIG. 19 representing the conventional technique and FIG. 1 representing the first embodiment, the thermal energy storage tank 1 in the first embodiment is in a higher-temperature state. Therefore, the first embodiment has a larger thermal energy storage amount than the conventional technique.

The first solid sensible heat storage material 19 with a small particle size incurs a large pressure loss of the air 5 during a thermal energy storage operation and a thermal dissipation operation, which are when the air 5 flows. Therefore, if the first solid sensible heat storage material 19 was to constitute all of the solid sensible heat storage materials 23 in the thermal energy storage tank 1, a load on a blower (the first blower 3 during the thermal energy storage operation and the second blower 4 during the thermal dissipation operation) would become sufficiently large, resulting in high power consumption. Since the thermal energy storage system is a system that accumulates and utilizes energy, energy consumption is desirably reduced. Therefore, in the present embodiment, by arranging the first solid sensible heat storage material 19 only in a part of the areas in the thermal energy storage tank 1, the thermal energy storage amount is increased while reducing the load on the blower.

Generally, the smaller the cross-sectional area of a flow path of the air 5, the greater a flow velocity and the smaller a temperature change of the flowing air 5. Accordingly, due to the fact that the solid sensible heat storage materials 23 further downstream are also heated and the fact that the smaller the amount of solid sensible heat storage materials 23 per a cross section perpendicular to an airflow direction, the easier it is for temperature to rise, the gradient of the thermocline becomes more gradual.

Therefore, in the present embodiment, the first solid sensible heat storage material 19 is structured such that the cross-sectional area of the flow path thereof is, desirably, the same as or larger than the cross-sectional area of the flow path of the second area 35 near a boundary between the first area 34 and the second area 35. If the cross-sectional area of the flow path near the boundary between the first area 34 and the second area 35 is smaller than the cross-sectional area of the flow path in the second area 35, since the thermocline becomes more gradual, an effect of an increased thermal energy storage amount due to the steepening of the thermocline may decrease. In addition, when the thermal energy storage tank 1 includes n-number of types of the solid sensible heat storage materials 23, desirably, the solid sensible heat storage materials 23 are structured such that the cross-sectional area of the flow path of the first solid sensible heat storage material 19 is the same as or larger than the cross-sectional area of the flow path of the n-th area near a boundary between the first area 34 and the n-th area.

An incorporated amount of the first solid sensible heat storage material 19 is desirably set so that the eighth thermocline 39 is only present on the first area 34 at the end of a thermal energy storage operation. This is because, compared to the eighth thermocline 39 present on the first area 34 being steep when a thermocline is also present in an area other than the first area 34, since a thermocline not present on the first area 34 remains the second thermocline 27 that is not steep, the thermal energy storage amount can be further increased by making all thermoclines steep. For example, the incorporated amount can be set based on an actual value obtained by temperature measurement or set by a numerical calculation.

In addition, while the thermal energy storage system 200 according to the present embodiment is configured to use dissipated heat as a heat source for the steam turbine 10, the thermal energy storage system 200 may also be used for air conditioning and other applications. The applications are the same in all subsequent embodiments.

According to the present embodiment, the thermal energy storage tank 1 incorporates a plurality of types of solid sensible heat storage materials 23, and the first solid sensible heat storage material 19 being the solid sensible heat storage material 23 incorporated nearest to the outlet side during a thermal energy storage operation is made a thermal energy storage material with a smaller particle size than the second solid sensible heat storage material. Accordingly, the thermal energy storage tank 1 can increase the thermal energy storage amount in the first area 34 by suppressing a temperature rise of outlet air and lengthening a thermal energy storage operation time until the thermal energy storage operation-time allowable temperature 28 is reached.

In addition, whereas the pressure loss of the air 5 sufficiently increases when all of the thermal energy storage materials are replaced with the first solid sensible heat storage material 19, according to the present embodiment, only a part of the thermal energy storage materials is the first solid sensible heat storage material 19 and the other thermal energy storage materials are the second solid sensible heat storage material 18. Therefore, by suppressing the pressure loss of the thermal energy storage materials, the thermal energy storage amount can be increased while suppressing a load on the blower and suppressing power consumption.

Furthermore, according to the present embodiment, the thermal energy storage tank 1 can be structured such that the cross-sectional area of the flow path of the first solid sensible heat storage material 19 is the same as or larger than the cross-sectional area of the flow path of the second area 35 near a boundary between the first area 34 and the second area 35. Adopting such a structure prevents a thermocline from becoming gradual and an effect of increasing the thermal energy storage amount due to steepening of the thermocline from becoming diminished.

### Second Embodiment

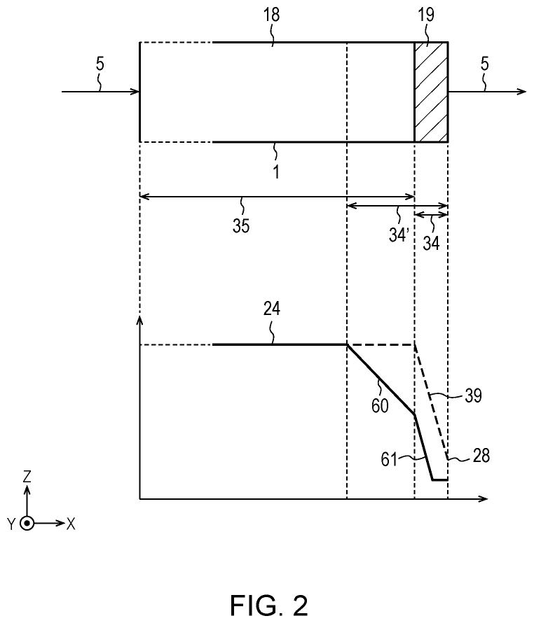

A second embodiment that corresponds to claims 1, 2, 3, and 10 will be described. FIG. 2 is a schematic view and a diagram showing a temperature distribution during a thermal energy storage operation of the thermal energy storage tank 1 according to the second embodiment.

Since an overall configuration diagram of the power conditioning system 100 including the thermal energy storage system 200 is similar to FIG. 18, a description thereof will not be repeated. An upper half of FIG. 2 shows a schematic view of the thermal energy storage tank 1 during a thermal energy storage operation and a lower half of FIG. 2 shows a temperature distribution of the thermal energy storage tank 1 during the thermal energy storage operation and temperatures at corresponding positions in the schematic view in the upper half.

In the present embodiment, a plurality of types of solid sensible heat storage materials 23 are incorporated in the thermal energy storage tank 1 in a similar manner to the first embodiment. While an example in which the thermal energy storage tank 1 incorporates two types of solid sensible heat storage materials 23 will be described in the present embodiment, the number of types of solid sensible heat storage materials 23 incorporated in the thermal energy storage tank 1 is not limited thereto. The thermal energy storage tank 1 may include any n-number of types (where n is an integer greater than or equal to 2) of solid sensible heat storage materials 23.

In the first embodiment, it was described that an incorporated amount of the first solid sensible heat storage material 19 is desirably set so that the eighth thermocline 39 is only present on the first area 34 at the end of a thermal energy storage operation. However, in FIG. 1, a temperature area that is not the eighth thermocline 39 or, in other words, a temperature area that is at the first thermal energy storage temperature 24 is present on the first area 34. Since the first solid sensible heat storage material 19 is an object that increases pressure loss of the air 5 as compared to the second solid sensible heat storage material 18, a load on a blower (the first blower 3 during a thermal energy storage operation and the second blower 4 during a thermal dissipation operation) becomes large, resulting in high power consumption. In consideration thereof, desirably, an incorporated amount of the first solid sensible heat storage material 19 is reduced to reduce pressure loss.

Therefore, in the present embodiment, a temperature area that is not the eighth thermocline 39 is set so as not to be present on the first area 34 at the end of a thermal energy storage operation to minimize the first area 34. In the present embodiment, for the purpose of comparison, an area in a case where the first area 34 is not a smallest area is represented as a first area 34′.

In the conventional technique, a thermocline at a time point where the outlet air reaches the thermal energy storage operation-time allowable temperature 28 is the second thermocline 27. On the other hand, at the same time point in FIG. 2, the thermocline becomes a ninth thermocline 60 in the second area 35 and a tenth thermocline 61 in the first area 34 that is the smallest area. Since the thermal energy storage tank 1 has not reached the thermal energy storage operation-time allowable temperature 28, the thermal energy storage operation is continued. Subsequently, while the outlet air reaches the thermal energy storage operation-time allowable temperature 28, the thermocline at that point is an eighth thermocline 39 and a same state as the lower half in FIG. 1 according to the first embodiment is created. Therefore, a similar thermal energy storage amount can be obtained even when the incorporated amount of the first solid sensible heat storage material 19 is reduced to the incorporated amount in the smallest area.

Therefore, by setting the incorporated amount of the first solid sensible heat storage material 19 to “an incorporated amount such that, during a thermal energy storage operation, a temperature area that is not the thermocline present on a temperature distribution of solid sensible heat storage materials is not present on a temperature distribution of the first solid sensible heat storage material 19 at the end of the thermal energy storage operation”, a same effect as a case of a larger incorporated amount can be obtained and the incorporated amount of the first solid sensible heat storage material 19 can be reduced while satisfying the condition.

According to the present embodiment, the thermal energy storage tank 1 sets a smallest area of the first solid sensible heat storage material 19 so that a temperature area that is not the eighth thermocline 39 is not present on the first area 34 at the end of a thermal energy storage operation. Accordingly, the thermal energy storage tank 1 can obtain a similar thermal energy storage amount as the thermal energy storage tank 1 according to the first embodiment while reducing the incorporated amount of the first solid sensible heat storage material 19, suppressing pressure loss of the air 5 due to thermal energy storage materials, and suppressing a load on the blower and suppressing power consumption. In other words, the power consumption by the blower can be minimized while maintaining a similar increase in the thermal energy storage amount as in the first embodiment.

### Third Embodiment

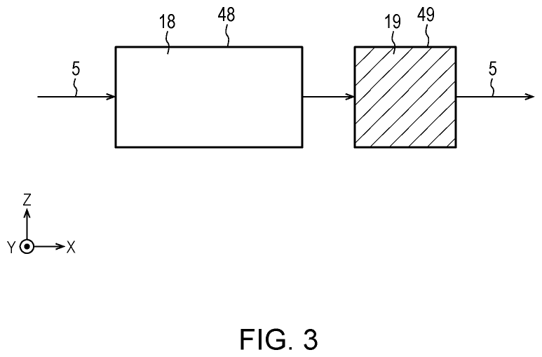

A third embodiment that corresponds to claims 4, 7, and 9 will be described. FIG. 3 shows a schematic view of a thermal energy storage tank according to the third embodiment.

Since an overall configuration diagram of the power conditioning system 100 including the thermal energy storage system 200 is similar to FIG. 18, a description thereof will not be repeated.

In the present embodiment, the thermal energy storage tank 1 is divided into a plurality of parts. In this example, the thermal energy storage tank 1 is divided into two parts. A thermal energy storage tank on a side into which the air 5 flows during a thermal energy storage operation will be referred to as a high temperature-side thermal energy storage tank 48 and a thermal energy storage tank on a side from which the air 5 flows out during the thermal energy storage operation will be referred to as a low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank into which the air 5 flows during a thermal energy storage operation will be referred to as the high temperature-side thermal energy storage tank 48 and other thermal energy storage tanks will be referred to as low temperature-side thermal energy storage tanks 49.

In addition, the thermal energy storage tank arranged most downstream during a thermal energy storage operation is also referred to as a first divided thermal energy storage tank and an m-th thermal energy storage tank on an upstream side as counted from the first divided thermal energy storage tank is also referred to as an m-th divided thermal energy storage tank. In this example, the low temperature-side thermal energy storage tank 49 corresponds to the first divided thermal energy storage tank and the high temperature-side thermal energy storage tank 48 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the example shown in FIG. 3, the high temperature-side thermal energy storage tank 48 incorporates the second solid sensible heat storage material 18 and the low temperature-side thermal energy storage tank 49 incorporates the first solid sensible heat storage material 19. In addition, while the first solid sensible heat storage material 19 is the only thermal energy storage material incorporated in the low temperature-side thermal energy storage tank 49 in the example shown in FIG. 3, only an outlet side from which the air 5 flows out during a thermal energy storage operation may incorporate the first solid sensible heat storage material 19 and the second solid sensible heat storage material 18 may be incorporated further upstream inside the low temperature-side thermal energy storage tank 49. Each of the high temperature-side thermal energy storage tank 48 and the low temperature-side thermal energy storage tank 49 may incorporate a plurality of types of thermal energy storage materials. If only one type of thermal energy storage material is used in each of the high temperature-side thermal energy storage tank 48 and the low temperature-side thermal energy storage tank 49, there is no need to provide partition plates in the thermal energy storage tanks, thereby enabling a simplified structure to be adopted and maintainability to be improved. In addition, while the thermal energy storage tank 1 uses the air 5 as a high-temperature heat source fluid in this example, another gas may be used or a liquid may be used instead of a gas. The air 5 is an example of a fluid that is a thermal medium.

Furthermore, when the low temperature-side thermal energy storage tank 49 includes n-number of types of solid sensible heat storage materials 23, the first solid sensible heat storage material 19 is a thermal energy storage material with a smaller particle size than an n-th solid sensible heat storage material arranged on an upstream side during a thermal energy storage operation.

In addition, desirably, the cross-sectional area of the flow path of the first solid sensible heat storage material 19 is the same as or larger than the cross-sectional area of the flow path of an n-th area near a boundary between the first area 34 and the n-th area.

When a plurality of types of the solid sensible heat storage materials 23 are to be incorporated in the low temperature-side thermal energy storage tank 49, the incorporated amount of the first solid sensible heat storage material 19 is desirably set so that the eighth thermocline 39 is only present on the first area 34 at the end of a thermal energy storage operation.

According to the present embodiment, as described above, the thermal energy storage tank 1 incorporates a plurality of types of solid sensible heat storage materials 23, and the first solid sensible heat storage material 19 being the solid sensible heat storage material 23 incorporated nearest to the outlet side during a thermal energy storage operation in the first divided thermal energy storage tank is made a thermal energy storage material with a smaller particle size than the second solid sensible heat storage material. Accordingly, the thermal energy storage tank 1 can increase the thermal energy storage amount in the first area 34 by suppressing a temperature rise of outlet air and lengthening a thermal energy storage operation time until the thermal energy storage operation-time allowable temperature 28 is reached.

In addition, whereas the pressure loss of the air 5 sufficiently increases when all of the thermal energy storage materials are replaced with the first solid sensible heat storage material 19, according to the present embodiment, only a part of the thermal energy storage materials is the first solid sensible heat storage material 19 and the other thermal energy storage materials are the second solid sensible heat storage material 18. Therefore, by suppressing the pressure loss of the thermal energy storage materials, the thermal energy storage amount can be increased while suppressing a load on the blower and suppressing power consumption.

### Fourth Embodiment

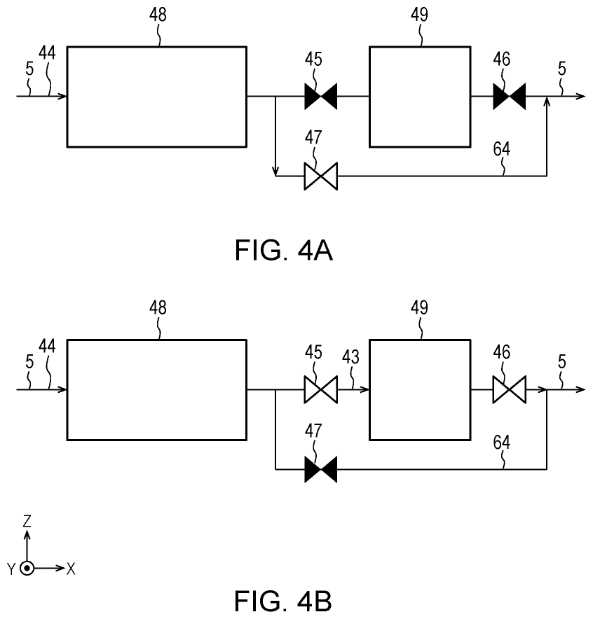

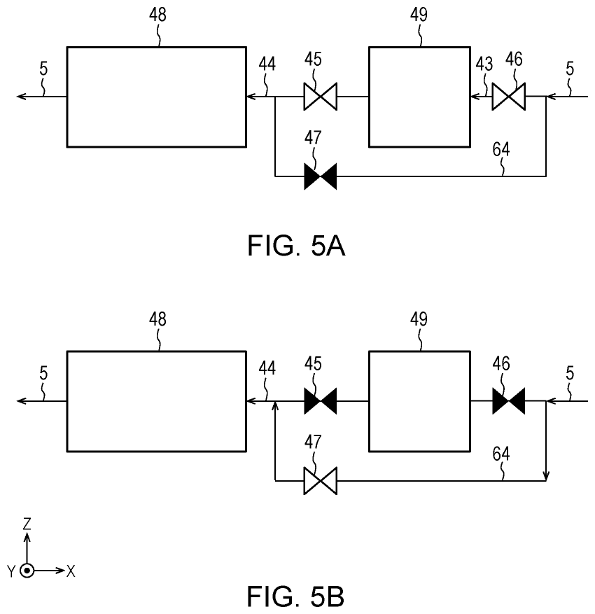

A fourth embodiment that corresponds to claims 4, 5, 7, and 9 will be described. FIG. 4 shows a schematic view during a thermal energy storage operation of the thermal energy storage tank 1 according to the fourth embodiment and FIG. 5 shows a schematic view during a thermal dissipation operation of the thermal energy storage tank 1 according to the fourth embodiment.

Since an overall configuration diagram of the power conditioning system 100 including the thermal energy storage system 200 is similar to FIG. 18, a description thereof will not be repeated.

In addition, in the present embodiment, the thermal energy storage tank 1 is divided into a plurality of parts in a similar manner to the embodiment described above. In this example, the thermal energy storage tank 1 is divided into two parts. A thermal energy storage tank on a side into which the air 5 flows during a thermal energy storage operation will be referred to as the high temperature-side thermal energy storage tank 48 and a thermal energy storage tank on a side from which the air 5 flows out during the thermal energy storage operation will be referred to as the low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank on a side from which the air 5 flows out during a thermal energy storage operation will be referred to as the low temperature-side thermal energy storage tank 49 and other thermal energy storage tanks will be referred to as high temperature-side thermal energy storage tanks 48.

In addition, the thermal energy storage tank arranged most downstream during a thermal energy storage operation is also referred to as a first divided thermal energy storage tank and an m-th thermal energy storage tank on an upstream side as counted from the first divided thermal energy storage tank is also referred to as an m-th divided thermal energy storage tank. In this example, the low temperature-side thermal energy storage tank 49 corresponds to the first divided thermal energy storage tank and the high temperature-side thermal energy storage tank 48 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the example shown in FIG. 4, the high temperature-side thermal energy storage tank 48 incorporates the second solid sensible heat storage material 18 and the low temperature-side thermal energy storage tank 49 incorporates the first solid sensible heat storage material 19. In addition, while the first solid sensible heat storage material 19 is the only thermal energy storage material incorporated in the low temperature-side thermal energy storage tank 49 in the example shown in FIG. 4, alternatively, a plurality of types of thermal energy storage materials may be incorporated such as only an outlet side from which the air 5 flows out during a thermal energy storage operation incorporating the first solid sensible heat storage material 19 and the second solid sensible heat storage material 18 being incorporated further upstream inside the low temperature-side thermal energy storage tank 49.

Furthermore, when the low temperature-side thermal energy storage tank 49 includes n-number of types of solid sensible heat storage materials 23, the first solid sensible heat storage material 19 is a thermal energy storage material with a smaller particle size than an n-th solid sensible heat storage material arranged on an upstream side during a thermal energy storage operation.

In addition, the first solid sensible heat storage material 19 is structured such that the cross-sectional area of the flow path thereof is, desirably, the same as or larger than the cross-sectional area of the flow path of an n-th area near a boundary between the first area 34 and the n-th area.

When the low temperature-side thermal energy storage tank 49 is to incorporate a plurality of types of the solid sensible heat storage materials 23, the incorporated amount of the first solid sensible heat storage material 19 is desirably set so that the eighth thermocline 39 is only present on the first area 34 at the end of a thermal energy storage operation.

In the embodiment described above, it was described that due to the thermal energy storage tank 1 incorporating the first solid sensible heat storage material 19, the thermal energy storage tank 1 can increase the thermal energy storage amount in the first area 34 by suppressing a temperature rise of outlet air and lengthening a thermal energy storage operation time until the thermal energy storage operation-time allowable temperature 28 is reached. On the other hand, pressure loss is desirably suppressed in the first area 34 since a large pressure loss of a flow of the air 5 causes power consumption by the blower to increase during a thermal energy storage operation or a thermal dissipation operation. Therefore, as shown in FIG. 4, the thermal energy storage tank 1 according to the present embodiment is equipped with a low temperature-side bypass flow path 64 that bypasses the low temperature-side thermal energy storage tank 49 and valves 45 to 47. In addition, in FIG. 4, the valve 47 shown in white indicates being in an “open” state and each of the valves 45 and 46 shown in black indicates being in a “closed” state. When the thermal energy storage tank 1 includes the m-th divided thermal energy storage tank, the low temperature-side bypass flow path 64 is connected so as to bypass the first divided thermal energy storage tank (in other words, the low temperature-side thermal energy storage tank 49).

While the valves are configured in this example so that one valve is provided at the outlet and the inlet, respectively, during a thermal energy storage operation in the low temperature-side thermal energy storage tank 49 and one valve is arranged in the low temperature-side bypass flow path 64, the number of valves is not limited thereto. The thermal energy storage tank 1 need only be equipped with one or more valves that bypass the low temperature-side thermal energy storage tank 49 by switching between a flow path of the air 5 to the side of the low temperature-side thermal energy storage tank 49 and a flow path of the air to the side of the low temperature-side bypass flow path 64. A valve that bypasses the low temperature-side thermal energy storage tank 49 will also be referred to as a low temperature-side bypass valve. The valves 45 to 47 are examples of the low temperature-side bypass valve.

At the start of a thermal energy storage operation, as shown in FIG. 4A, the thermal energy storage tank 1 closes the valves 45 and 46 and opens the valve 47. After flowing in the high temperature-side thermal energy storage tank 48 as high temperature-side thermal energy storage tank inflow air 44, the air 5 flows through the low temperature-side bypass flow path 64 without flowing into the low temperature-side thermal energy storage tank 49. Once the thermal energy storage operation proceeds and the first thermocline 26 is ready to move to the inlet of the low temperature-side thermal energy storage tank 49, as shown in FIG. 4B, the thermal energy storage tank 1 opens the valves 45 and 46 and closes the valve 47. The air 5 flows in the low temperature-side thermal energy storage tank 49 as low temperature-side thermal energy storage tank inflow air 43 without flowing into the low temperature-side bypass flow path 64. The first solid sensible heat storage material 19 in the low temperature-side thermal energy storage tank 49 is heated, the first thermocline 26 advances toward the downstream side and, subsequently, the outlet temperature reaches the thermal energy storage operation-time allowable temperature 28 and the thermal energy storage operation ends.

Since an opening/closing timing of each valve when the first thermocline 26 moves to the low temperature-side thermal energy storage tank 49 can be calculated and determined from a start time point of the thermal energy storage operation, the opening/closing timing may be calculated and determined in such a manner or a temperature sensor may be installed near an outlet of the high temperature-side thermal energy storage tank 48 or the like and a time point where the temperature provided by the temperature sensor reaches a temperature set in advance may be adopted. In addition, control of each valve may be implemented manually by an operator or implemented automatically using information from a sensor or a timer.

At the start of a thermal dissipation operation, as shown in FIG. 5A, the thermal energy storage tank 1 opens the valve 45 and the valve 46 and closes the valve 47. After flowing in the low temperature-side thermal energy storage tank 49 as low temperature-side thermal energy storage tank inflow air 43, the air 5 flows in the high temperature-side thermal energy storage tank 48 as high temperature-side thermal energy storage tank inflow air 44. Once the thermal dissipation operation proceeds and the seventh thermocline 38 (third thermocline 29) finishes moving to the high temperature-side thermal energy storage tank 48, as shown in FIG. 5B, the thermal energy storage tank 1 closes the valves 45 and 46 and opens the valve 47. The air 5 flows through the low temperature-side bypass flow path 64 without flowing into the low temperature-side thermal energy storage tank 49. Subsequently, the outlet temperature reaches the thermal dissipation operation-time allowable temperature 31 and the thermal dissipation operation ends.

Since an opening/closing timing of each valve when the seventh thermocline 38 (third thermocline 29) moves to the high temperature-side thermal energy storage tank 48 can be calculated and determined from a start time point of the thermal dissipation operation, the opening/closing timing may be calculated and determined in such a manner or a temperature sensor may be installed near an outlet of the low temperature-side thermal energy storage tank 49 or the like and a time point where the temperature provided by the temperature sensor reaches a temperature set in advance may be adopted. In addition, control of each valve may be implemented manually by an operator or implemented automatically using information from a sensor or a timer.

According to the present embodiment, when the low temperature-side thermal energy storage tank 49 is bypassed during a thermal energy storage operation and a thermal dissipation operation in the thermal energy storage tank 1, the air 5 does not flow to the first solid sensible heat storage material 19 that increases pressure loss. Therefore, pressure loss due to the first solid sensible heat storage material 19 can be reduced to zero. Accordingly, in addition to the effect of being able to increase the thermal energy storage amount in the first area 34 by suppressing a temperature rise of outlet air and lengthening a thermal energy storage operation time until the thermal energy storage operation-time allowable temperature 28 is reached, the thermal energy storage tank 1 can further suppress a load on the blower and suppress power consumption by suppressing pressure loss in the flow of the air 5 during the thermal energy storage operation and the thermal dissipation operation.

### Fifth Embodiment

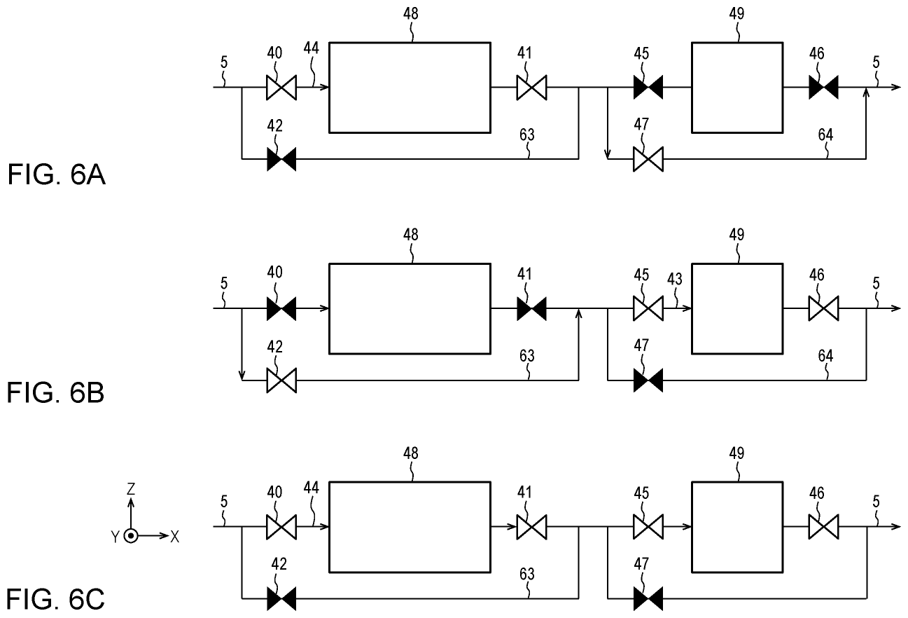

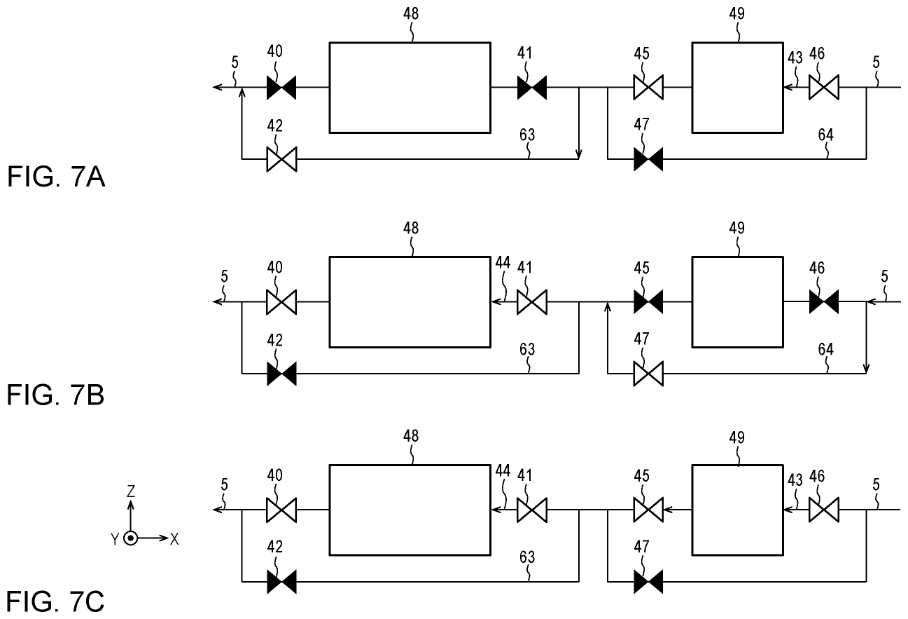

A fifth embodiment that corresponds to claims 4, 5, 6, 7, and 9 will be described. FIG. 6 shows a schematic view during a thermal energy storage operation of the thermal energy storage tank 1 according to the fifth embodiment and FIG. 7 shows a schematic view during a thermal dissipation operation of the thermal energy storage tank 1 according to the fifth embodiment.

Since an overall configuration diagram of the power conditioning system 100 including the thermal energy storage system 200 is similar to FIG. 18, a description thereof will not be repeated.

In addition, in the present embodiment, the thermal energy storage tank 1 is divided into a plurality of parts in a similar manner to the embodiment described above. In this example, the thermal energy storage tank 1 is divided into two parts. A thermal energy storage tank on a side into which the air 5 flows during a thermal energy storage operation will be referred to as the high temperature-side thermal energy storage tank 48 and a thermal energy storage tank on a side from which the air 5 flows out during the thermal energy storage operation will be referred to as the low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank on a side from which the air 5 flows out during a thermal energy storage operation will be referred to as the low temperature-side thermal energy storage tank 49 and other thermal energy storage tanks will be referred to as high temperature-side thermal energy storage tanks 48.

In addition, the thermal energy storage tank arranged most downstream during a thermal energy storage operation is also referred to as a first divided thermal energy storage tank and an m-th thermal energy storage tank on an upstream side as counted from the first divided thermal energy storage tank is also referred to as an m-th divided thermal energy storage tank. In this example, the low temperature-side thermal energy storage tank 49 corresponds to the first divided thermal energy storage tank and the high temperature-side thermal energy storage tank 48 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the example shown in FIG. 6, the high temperature-side thermal energy storage tank 48 incorporates the second solid sensible heat storage material 18 and the low temperature-side thermal energy storage tank 49 incorporates the first solid sensible heat storage material 19. In addition, while the first solid sensible heat storage material 19 is the only thermal energy storage material incorporated in the low temperature-side thermal energy storage tank 49 in the example shown in FIG. 6, only an outlet side from which the air 5 flows out during a thermal energy storage operation may incorporate the first solid sensible heat storage material 19 and the second solid sensible heat storage material 18 may be incorporated further upstream inside the low temperature-side thermal energy storage tank 49. Each of the high temperature-side thermal energy storage tank 48 and the low temperature-side thermal energy storage tank 49 may incorporate a plurality of types of thermal energy storage materials.

Furthermore, when the low temperature-side thermal energy storage tank 49 includes n-number of types of solid sensible heat storage materials 23, the first solid sensible heat storage material 19 is a thermal energy storage material with a smaller particle size than an n-th solid sensible heat storage material arranged on an upstream side during a thermal energy storage operation.

In addition, desirably, the cross-sectional area of the flow path of the first solid sensible heat storage material 19 is the same as or larger than the cross-sectional area of the flow path of an n-th area near a boundary between the first area 34 and the n-th area.

When the low temperature-side thermal energy storage tank 49 is to incorporate a plurality of types of the solid sensible heat storage materials 23, the incorporated amount of the first solid sensible heat storage material 19 is desirably set so that the eighth thermocline 39 is only present on the first area 34 at the end of a thermal energy storage operation.

In the fifth embodiment described above, it was described that due to the thermal energy storage tank 1 incorporating the first solid sensible heat storage material 19, the thermal energy storage temperature rises in the first area 34 and the thermal energy storage tank 1 can increase the thermal energy storage amount in the first area 34. On the other hand, since pressure loss due to the second solid sensible heat storage material 18 is not suppressed when the air 5 flows in the high temperature-side thermal energy storage tank 48 in the fifth embodiment, a total pressure loss of the high temperature-side thermal energy storage tank 48 and the low temperature-side thermal energy storage tank 49 is large even if the pressure loss of the low temperature-side thermal energy storage tank 49 is suppressed and, desirably, the total pressure loss is also suppressed. Therefore, as shown in FIG. 6, the thermal energy storage tank 1 according to the present embodiment is equipped with a high temperature-side bypass flow path 63 that bypasses the high temperature-side thermal energy storage tank 48 and valves 40 to 42. When the thermal energy storage tank 1 includes the m-th divided thermal energy storage tank, the high temperature-side bypass flow path 63 is connected so as to bypass second to m-th divided thermal energy storage tanks (in other words, the entire high temperature-side thermal energy storage tank 48). In addition, one or more high temperature-side bypass flow paths 63 may be connected so as to divide each of the second to m-th divided thermal energy storage tanks.

While the valves are configured in this example so that one valve is provided at the outlet and the inlet, respectively, during a thermal energy storage operation in the high temperature-side thermal energy storage tank 48 and one valve is arranged in the high temperature-side bypass flow path 63, the number of valves is not limited thereto. The thermal energy storage tank 1 need only be equipped with one or more valves that switch between a flow path of the air 5 to the side of the high temperature-side thermal energy storage tank 48 and a flow path of the air 5 to the side of the high temperature-side bypass flow path 63. A valve that bypasses the high temperature-side thermal energy storage tank 48 will also be referred to as a high temperature-side bypass valve. The valves 40 to 42 are examples of the high temperature-side bypass valve.

In addition, while the valves are configured in this example so that one valve is provided at the outlet and the inlet, respectively, during a thermal energy storage operation in the low temperature-side thermal energy storage tank 49 and one valve is arranged in the low temperature-side bypass flow path 64, the number of valves is not limited thereto. The thermal energy storage tank 1 need only be equipped with one or more valves that bypass the low temperature-side thermal energy storage tank 49 by switching between a flow path of the air 5 to the side of the low temperature-side thermal energy storage tank 49 and a flow path of the air to the side of the low temperature-side bypass flow path 64. A valve that bypasses the low temperature-side thermal energy storage tank 49 will also be referred to as a low temperature-side bypass valve. The valves 45 to 47 are examples of the low temperature-side bypass valve.

At the start of a thermal energy storage operation, as shown in FIG. 6A, the thermal energy storage tank 1 opens the valve 40 and the valve 41 and closes the valve 42. In addition, the thermal energy storage tank 1 closes the valves 45 and 46 and opens the valve 47. After flowing in the high temperature-side thermal energy storage tank 48 as high temperature-side thermal energy storage tank inflow air 44, the air 5 flows through the low temperature-side bypass flow path 64 without flowing into the low temperature-side thermal energy storage tank 49. Once the first solid sensible heat storage material 19 in the high temperature-side thermal energy storage tank 48 is heated and the third thermocline 29 moves to the low temperature-side thermal energy storage tank 49, via a state shown in FIG. 6C to be described later, the thermal energy storage tank 1 closes the valves 40, 41, and 47 and opens the valves 42, 45, and 46 as shown in FIG. 6B. The air 5 flows through the high temperature-side bypass flow path 63 without flowing into the high temperature-side thermal energy storage tank 48 and flows in the low temperature-side thermal energy storage tank 49 as low temperature-side thermal energy storage tank inflow air 43 without flowing into the low temperature-side bypass flow path 64. The second solid sensible heat storage material 18 in the low temperature-side thermal energy storage tank 49 is heated, the seventh thermocline 38 to which the third thermocline 29 has changed advances toward the downstream side and, subsequently, the outlet temperature reaches the thermal energy storage operation-time allowable temperature 28 and the thermal energy storage operation ends.

Since the first thermocline 26 is inclined, as shown in FIG. 6C, when the third thermocline 29 reaches the outlet of the high temperature-side thermal energy storage tank 48 after the start of a thermal energy storage operation, the valves 40, 41, 45, and 46 are opened and the valves 42 and 47 are closed to cause the air 5 to flow in both the high temperature-side thermal energy storage tank 48 and the low temperature-side thermal energy storage tank 49. At this point, the first thermocline 26 is present near the outlet of the high temperature-side thermal energy storage tank 48 and near the inlet of the low temperature-side thermal energy storage tank 49. Subsequently, once the third thermocline 29 finishes passing through the outlet of the high temperature-side thermal energy storage tank 48, the valve 42 is closed and the valves 40 and 41 are opened to cause the air 5 to flow in the high temperature-side bypass flow path 63 and the low temperature-side thermal energy storage tank 49.

Since an opening/closing timing of each valve when the first thermocline 26 moves to the low temperature-side thermal energy storage tank 49 can be calculated and determined from a start time point of the thermal energy storage operation of the high temperature-side thermal energy storage tank 48, the opening/closing timing may be calculated and determined in such a manner or a temperature sensor may be installed near an outlet of the high temperature-side thermal energy storage tank 48 or the like and a time point where the temperature provided by the temperature sensor reaches a temperature set in advance may be adopted. In addition, control of each valve may be implemented manually by an operator or implemented automatically using information from a sensor or a timer.

At the start of a thermal dissipation operation, as shown in FIG. 7A, the thermal energy storage tank 1 closes the valves 40 and 41 and opens the valve 42. In addition, the thermal energy storage tank 1 opens the valves 45 and 46 and closes the valve 47. After flowing in the low temperature-side thermal energy storage tank 49 as low temperature-side thermal energy storage tank inflow air 43, the air 5 flows through the high temperature-side bypass flow path 63 without flowing into the high temperature-side thermal energy storage tank 48. Once the thermal dissipation operation proceeds and the seventh thermocline 38 moves to the high temperature-side thermal energy storage tank 48, via the state shown in FIG. 7C to be described later, as shown in FIG. 7B, the thermal energy storage tank 1 opens the valves 40 and 41 and closes the valve 42. In addition, the thermal energy storage tank 1 closes the valves 45 and 46 and opens the valve 47. After flowing through the low temperature-side bypass flow path 64 without flowing into the low temperature-side thermal energy storage tank 49, the air 5 flows in the high temperature-side thermal energy storage tank 48 as high temperature-side thermal energy storage tank inflow air 44. Subsequently, the outlet temperature reaches the thermal dissipation operation-time allowable temperature 31 and the thermal dissipation operation ends.

Since the seventh thermocline 38 is inclined, as shown in FIG. 7C, when the seventh thermocline 38 reaches the outlet of the low temperature-side thermal energy storage tank 49 after the start of a thermal dissipation operation, the valves 40, 41, 45, and 46 are opened and the valves 42 and 47 are closed to cause the air 5 to flow in both the low temperature-side thermal energy storage tank 49 and the high temperature-side thermal energy storage tank 48. At this point, the third thermocline 29 is present near the outlet of the low temperature-side thermal energy storage tank 49 and near the inlet of the high temperature-side thermal energy storage tank 48. Subsequently, once the seventh thermocline 38 finishes passing through the outlet of the low temperature-side thermal energy storage tank 49, the valves 45 and 46 are closed and the valve 47 is opened to cause the air 5 to flow in the low temperature-side bypass flow path 64 and the high temperature-side thermal energy storage tank 48.

Since an opening/closing timing of each valve when the seventh thermocline 38 moves to the high temperature-side thermal energy storage tank 48 can be calculated and determined from a start time point of the thermal dissipation operation, the opening/closing timing may be calculated and determined in such a manner or a temperature sensor may be installed near an outlet of the low temperature-side thermal energy storage tank 49 or the like and a time point where the temperature provided by the temperature sensor reaches a temperature set in advance may be adopted. In addition, control of each valve may be implemented manually by an operator or implemented automatically using information from a sensor or a timer.

According to the present embodiment, the thermal energy storage tank 1 is equipped with the low temperature-side bypass flow path 64, and when the low temperature-side thermal energy storage tank 49 is bypassed during a thermal energy storage operation and a thermal dissipation operation, the air 5 does not flow to the first solid sensible heat storage material 19 that increases pressure loss. Therefore, pressure loss due to the first solid sensible heat storage material 19 can be reduced to zero. As a result, when the air 5 does not flow in the low temperature-side thermal energy storage tank 49, a total pressure loss of the high temperature-side thermal energy storage tank 48 and the low temperature-side thermal energy storage tank 49 is not only smaller as compared to a case not provided with each bypass flow path as in the third embodiment but also smaller as compared to a case only provided with the low temperature-side bypass flow path 64 as in the fifth embodiment. Accordingly, in addition to the effect of increasing the thermal energy storage amount in the first area 34 by suppressing a temperature rise of outlet air and lengthening a thermal energy storage operation time until the thermal energy storage operation-time allowable temperature 28 is reached, the thermal energy storage tank 1 can further suppress a load on the blower and suppress power consumption by suppressing pressure loss in the flow of the air 5 during the thermal energy storage operation and the thermal dissipation operation.

In addition, according to the present embodiment, the thermal energy storage tank 1 is equipped with the high temperature-side bypass flow path 63, and when the high temperature-side thermal energy storage tank 48 is bypassed during a thermal energy storage operation and a thermal dissipation operation, the air 5 does not flow to the second solid sensible heat storage material 18. Therefore, pressure loss due to the second solid sensible heat storage material 18 can be reduced to zero. As a result, even when the air 5 does not flow in the high temperature-side thermal energy storage tank 48, a total pressure loss of the high temperature-side thermal energy storage tank 48 and the low temperature-side thermal energy storage tank 49 is smaller as compared to a case not provided with each bypass flow path as in the third embodiment. Accordingly, the thermal energy storage tank 1 can increase the thermal energy storage amount in the first area 34 by suppressing a temperature rise of outlet air and lengthening a thermal energy storage operation time until a heat-resistance temperature of valves or the blower is reached and further suppress pressure loss in the flow of the air 5 during the thermal energy storage operation and the thermal dissipation operation.

### Sixth Embodiment

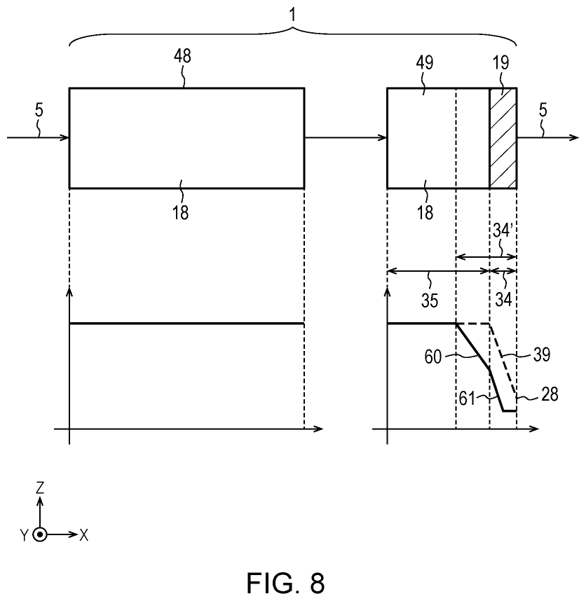

A sixth embodiment that corresponds to claims 4, 5, 6, 7, 8, and 11 will be described. FIG. 8 is a schematic view and a diagram showing a temperature distribution during a thermal energy storage operation of the thermal energy storage tank 1 according to the sixth embodiment.

Since an overall configuration diagram of the power conditioning system 100 including the thermal energy storage system 200 is similar to FIG. 18, a description thereof will not be repeated. An upper half of FIG. 8 shows a schematic view of the thermal energy storage tank 1 during a thermal energy storage operation and a lower half of FIG. 8 shows a temperature distribution of the thermal energy storage tank 1 during the thermal energy storage operation and temperatures at corresponding positions in the schematic view in the upper half.

Even in the present embodiment, a plurality of types of solid sensible heat storage materials 23 are incorporated in the thermal energy storage tank 1 in a similar manner to the third embodiment. While an example in which the thermal energy storage tank 1 incorporates two types of solid sensible heat storage materials 23 will be described in the present embodiment, the number of types of solid sensible heat storage materials 23 incorporated in the thermal energy storage tank 1 is not limited thereto. The thermal energy storage tank 1 may include any n-number of types (where n is an integer greater than or equal to 2) of solid sensible heat storage materials 23.

In the third embodiment, it was described that an incorporated amount of the first solid sensible heat storage material 19 is desirably set so that the eighth thermocline 39 is only present on the first area 34 at the end of a thermal energy storage operation. Since the first solid sensible heat storage material 19 is an object that increases pressure loss of the air 5 as compared to the second solid sensible heat storage material 18, a load on a blower (the first blower 3 during a thermal energy storage operation and the second blower 4 during a thermal dissipation operation) becomes large, resulting in high power consumption. In consideration thereof, desirably, an incorporated amount of the first solid sensible heat storage material 19 is reduced to reduce pressure loss.

Therefore, in the present embodiment, the first area 34 is set so that the eighth thermocline 39 is only present on the first area 34 at the end of a thermal energy storage operation. Furthermore, in the present embodiment, a temperature area that is not the eighth thermocline 39 is set so as not to be present on the first area 34 at the end of the thermal energy storage operation to minimize the first area 34. In the present embodiment, for the purpose of comparison, an area in a case where the first area 34 is not a smallest area is represented as the first area 34′.

When the low temperature-side thermal energy storage tank 49 is filled with the second solid sensible heat storage material 18, a thermocline at a time point where the outlet air reaches the thermal energy storage operation-time allowable temperature 28 is the second thermocline 27. On the other hand, at the same time point in FIG. 8, the thermocline becomes a ninth thermocline 60 in the second area 35 and a tenth thermocline 61 in the first area 34 that is the smallest area. Since the thermal energy storage tank 1 has not reached the thermal energy storage operation-time allowable temperature 28, the thermal energy storage operation is continued. Subsequently, while the outlet air reaches the thermal energy storage operation-time allowable temperature 28, the thermocline at that point is an eighth thermocline 39 and a same state as the lower half in FIG. 1 according to the first embodiment is created. Therefore, a similar thermal energy storage amount can be obtained even when the incorporated amount of the first solid sensible heat storage material 19 is reduced to the incorporated amount in the smallest area. The technique according to the present embodiment can be applied to the third to fifth embodiments. While the thermal energy storage material incorporated in the low temperature-side thermal energy storage tank 49 is only the first solid sensible heat storage material 19 in the example shown in FIG. 3, in this case, a size of the thermal energy storage tank 48 is determined so that an incorporated amount of the first solid sensible heat storage material 19 prevents a temperature area that is not the eighth thermocline 39 from being present on the first area 34 at the end of a thermal energy storage operation.

Therefore, by setting the incorporated amount of the first solid sensible heat storage material 19 to “an incorporated amount such that, during a thermal energy storage operation, a thermocline present on a temperature distribution of solid sensible heat storage materials is only present on a temperature distribution of the first solid sensible heat storage material 19 at the end of the thermal energy storage operation”, a same effect as a case of a larger incorporated amount can be obtained and the incorporated amount of the first solid sensible heat storage material 19 can be reduced while satisfying the condition.

In addition, even the thermal energy storage tank 1 described in the fourth and fifth embodiments can be configured in a similar manner to the thermal energy storage tank 1 described in the present embodiment. In other words, even when the thermal energy storage tank 1 is equipped with the high temperature-side bypass flow path 63 and the low temperature-side bypass flow path 64, a similar effect to the present embodiment can be produced by setting the incorporated amount of the first solid sensible heat storage material 19 so that the eighth thermocline 39 is only present on the first area 34 at the end of a thermal dissipation operation.

According to the present embodiment, the thermal energy storage tank 1 sets a smallest area of the first solid sensible heat storage material 19 so that a temperature area that is not the eighth thermocline 39 is not present on the first area 34 at the end of a thermal energy storage operation. Accordingly, the thermal energy storage tank 1 can obtain a similar thermal energy storage amount as the thermal energy storage tank 1 according to the first embodiment while reducing the incorporated amount of the first solid sensible heat storage material 19, suppressing pressure loss of the air 5 due to thermal energy storage materials, and suppressing a load on the blower and suppressing power consumption. In other words, the power consumption by the blower can be minimized while maintaining a similar increase in the thermal energy storage amount as in the third embodiment. While the eighth thermocline 39 is desirably set so as to be present only on the first area 34 when setting the incorporated amount of the first solid sensible heat storage material 19 so that a temperature area that is not the eighth thermocline 39 is not present in the first area 34 at the end of a thermal energy storage operation, when a reduction in power consumption due to a reduction in pressure loss is to be prioritized over maximizing an effect of increasing a thermal energy storage amount, the temperature area that is not the eighth thermocline 39 may be set so as not to be present on the first area 34 at the end of a thermal energy storage operation while causing the eighth thermocline 39 to be present on other than the first area 34.

### Seventh Embodiment

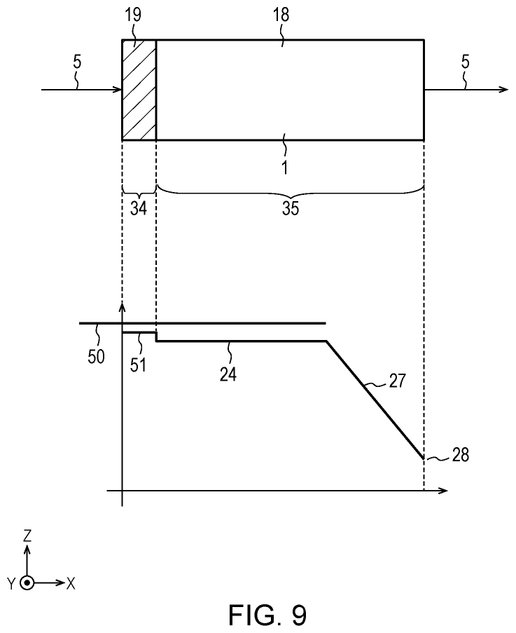

A seventh embodiment that corresponds to claims 12, 13, and 20 will be described. FIG. 9 is a schematic view and a diagram showing a temperature distribution during a thermal energy storage operation of the thermal energy storage tank 1 according to the seventh embodiment.

Since an overall configuration diagram of the power conditioning system 100 including the thermal energy storage system 200 is similar to FIG. 18, a description thereof will not be repeated. An upper half of FIG. 9 shows a schematic view of the thermal energy storage tank 1 during a thermal energy storage operation and a lower half of FIG. 9 shows a temperature distribution of the thermal energy storage tank 1 during the thermal energy storage operation and temperatures at corresponding positions in the schematic view in the upper half.

Unlike the conventional technique, the thermal energy storage tank 1 in FIG. 9 incorporates a plurality of types of solid sensible heat storage materials 23. While an example in which the thermal energy storage tank 1 includes two mutually different types of solid sensible heat storage materials 23 will be described in the present embodiment, the number of types of solid sensible heat storage materials 23 included in the thermal energy storage tank 1 is not limited thereto. The thermal energy storage tank 1 may include any n-number of types (where n is an integer greater than or equal to 2) of solid sensible heat storage materials 23. In addition, while the thermal energy storage tank 1 uses the air 5 as a high-temperature heat source fluid, another gas may be used or a liquid may be used instead of a gas. The air 5 is an example of a fluid that is a thermal medium.

In the present embodiment, the two mutually different types of solid sensible heat storage materials 23 will be referred to as the first solid sensible heat storage material 19 and the second solid sensible heat storage material 18. In addition, an area of the thermal energy storage tank 1 in which the first solid sensible heat storage material 19 is incorporated will be referred to as the first area 34 and an area in which the second solid sensible heat storage material 18 is incorporated will be referred to as the second area 35. As described above, the thermal energy storage tank 1 may include any n-number of types of solid sensible heat storage materials 23, in which case an n-th type of solid sensible heat storage material will be referred to as an n-th solid sensible heat storage material and an area of the thermal energy storage tank 1 in which the n-th solid sensible heat storage material is incorporated will be referred to as an n-th area.

In the present embodiment, the first solid sensible heat storage material 19 is incorporated nearest to an outlet side of the thermal energy storage tank 1 from which the air 5 flows out during a thermal dissipation operation. The second solid sensible heat storage material 18 is incorporated on an upstream side of the air 5 during a thermal dissipation operation than the first solid sensible heat storage material 19. In other words, in the thermal energy storage tank 1, the first area 34 becomes an area nearest to the inlet of the air 5 during a thermal energy storage operation and the second area 35 becomes an area on a downstream side of the first area 34 during the thermal energy storage operation.

The thermal energy storage tank 1 according to the present embodiment stores heat by causing heat to be absorbed by the first solid sensible heat storage material 19 and the second solid sensible heat storage material 18 from the air 5 during a thermal energy storage operation and dissipates heat by causing heat held by the first solid sensible heat storage material 19 and the second solid sensible heat storage material 18 to be absorbed by the air 5 during a thermal dissipation operation.

In addition, in the present embodiment, the first solid sensible heat storage material 19 is a thermal energy storage material with a smaller particle size than the second solid sensible heat storage material 18. Furthermore, when the thermal energy storage tank 1 includes n-number of types of solid sensible heat storage materials 23, the first solid sensible heat storage material 19 is a thermal energy storage material with a smaller particle size than an n-th solid sensible heat storage material arranged on an upstream side during a thermal energy storage operation.

For example, rocks are used as the first solid sensible heat storage material 19 and the second solid sensible heat storage material 18. The first solid sensible heat storage material 19 and the second solid sensible heat storage material 18 are desirably the same thermal energy storage material or thermal energy storage materials with similar physical properties.

A partition is provided between the first solid sensible heat storage material 19 and the second solid sensible heat storage material 18 by a mesh-like member such as a wire mesh or other members that allow the air 5 to pass through during a thermal energy storage operation and a thermal dissipation operation.

Since the first solid sensible heat storage material 19 has a small particle size, a surface area per volume is larger as compared to the second solid sensible heat storage material 18. In addition, the first solid sensible heat storage material 19 has a larger sum of surface areas per volume of an incorporated area of a solid sensible heat storage material than the second solid sensible heat storage material 18. Therefore, compared to the second solid sensible heat storage material 18, the first solid sensible heat storage material 19 has a larger contact surface area with high-temperature air during a thermal energy storage operation and more readily transfers heat. Accordingly, in the first area 34, a difference between the temperature of the air 5 and the thermal energy storage temperature further decreases.

Since a difference between the inflow air temperature 50 and a second thermal energy storage temperature 51 becomes smaller than a difference between the inflow air temperature 50 and the first thermal energy storage temperature 24, the second thermal energy storage temperature 51 becomes higher than the first thermal energy storage temperature 24. Therefore, in the first area 34, the thermal energy storage amount per unit volume has increased and the thermal energy storage amount has increased as compared to the conventional technique.

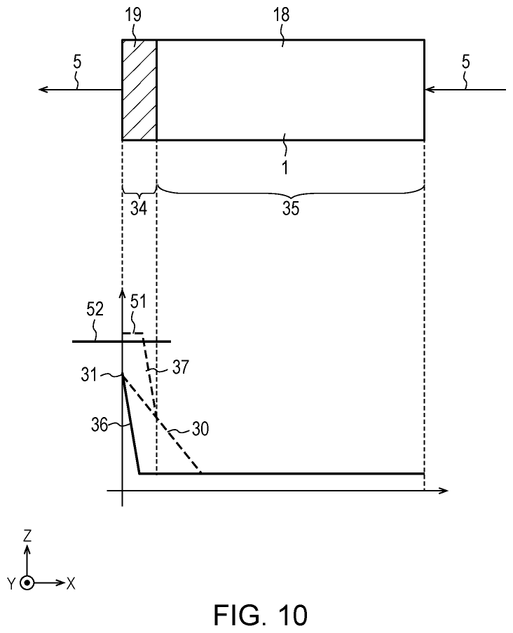

FIG. 10 is a schematic view and a diagram showing a temperature distribution during a thermal dissipation operation of the thermal energy storage tank 1 according to the seventh embodiment.

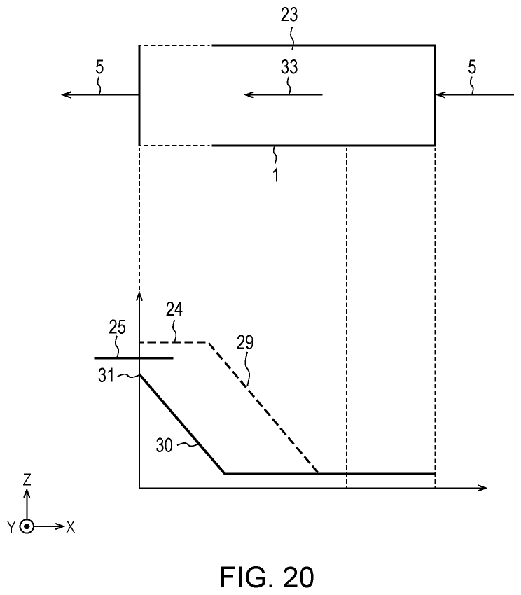

An upper half of FIG. 10 shows a schematic view of the thermal energy storage tank 1 and a lower half of FIG. 10 shows a temperature distribution of the thermal energy storage tank 1 during the thermal dissipation operation and temperatures at corresponding positions in the schematic view in the upper half. FIG. 20 according to the conventional technique corresponds to FIG. 10 according to the present embodiment.

Hereinafter, for the sake of description, in the present embodiment, an outflow air temperature of air that flows out from the thermal energy storage tank 1 during a thermal dissipation operation will be referred to as a second outflow air temperature 52. Since the first outflow air temperature 25 and the second outflow air temperature 52 are temperatures at which heat held by the solid sensible heat storage materials is absorbed by the air 5, the first outflow air temperature 25 and the second outflow air temperature 52 are respectively lower than the first thermal energy storage temperature 24 and the second thermal energy storage temperature 51.

During a thermal dissipation operation, while a thermocline at a time point where the first outflow air temperature 25 reaches the thermal dissipation operation-time allowable temperature 31 in the conventional technique is the fourth thermocline 30, a thermocline in the present embodiment at the same time point is a sixth thermocline 37 in the first area 34. Since a surface area per unit volume of the first solid sensible heat storage material 19 is large, the sixth thermocline 37 is steeper than the fourth thermocline 30. At this point, since the second outflow air temperature 52 has not reached the thermal dissipation operation-time allowable temperature 31, the thermal dissipation operation need not be ended and can be continued. In the present embodiment, while the second outflow air temperature 52 drops and reaches the thermal dissipation operation-time allowable temperature 31 after the thermal energy storage tank 1 continues the thermal dissipation operation, the thermocline at that point is a fifth thermocline 36. Therefore, a thermal dissipation operation time of the thermal energy storage tank 1 increases. In other words, the time available to supply heat to a heat demand destination increases.

In addition, comparing the temperature profile of the thermal energy storage tank 1 representing the conventional technique (a graph line including the thermocline 30) with the temperature profile of the thermal energy storage tank 1 representing the present embodiment (a graph line including the thermocline 36), the thermal energy storage tank 1 according to the present embodiment has a smaller amount of residual heat. Due to a smaller amount of residual heat at the end of the thermal dissipation operation and a larger amount of stored heat, the thermal dissipation amount in the present embodiment is larger than in the conventional technique.

Since the second thermal energy storage temperature 51 near the outlet during the thermal dissipation operation is higher than the first thermal energy storage temperature 24, the second outflow air temperature 52 is higher than the first outflow air temperature 25. In addition, since the first solid sensible heat storage material 19 has a larger contact surface area with the air 5 during a thermal dissipation operation than the second solid sensible heat storage material 18, heat is more readily transferred and a difference between the temperature of the air 5 and the second thermal energy storage temperature 51 decreases. Since a difference between the second outflow air temperature 52 and the second thermal energy storage temperature 51 becomes smaller than a difference between the first outflow air temperature 25 and the first thermal energy storage temperature 24, the second outflow air temperature 52 becomes higher even due to this effect. Therefore, the thermal energy storage tank 1 according to the present embodiment has a higher thermal dissipation temperature.

The first solid sensible heat storage material 19 with a small particle size incurs a large pressure loss of the air 5 during a thermal energy storage operation and a thermal dissipation operation, which are when the air 5 flows. Therefore, if the first solid sensible heat storage material 19 was to be used as all of the solid sensible heat storage materials 23 in the thermal energy storage tank 1, a load on a blower (the first blower 3 during the thermal energy storage operation and the second blower 4 during the thermal dissipation operation) would become sufficiently large, resulting in high power consumption. Since the thermal energy storage system is a system that accumulates and utilizes energy, energy consumption is desirably reduced. Therefore, in the present embodiment, by arranging the first solid sensible heat storage material 19 only in a part of the areas in the thermal energy storage tank 1, a thermal energy storage amount and a thermal dissipation amount are increased while reducing the load on the blower.

Generally, the smaller the cross-sectional area of a flow path of the air 5, the greater a flow velocity and the smaller a temperature change of the flowing air 5. Accordingly, due to the fact that the solid sensible heat storage materials 23 further downstream are also heated and the fact that the smaller the amount of solid sensible heat storage materials 23 per a cross section perpendicular to an airflow direction, the easier it is for temperature to rise, the gradient of a thermocline becomes more gradual.

Therefore, in the present embodiment, desirably, a structure is adopted such that the cross-sectional area of the flow path of the first solid sensible heat storage material 19 is the same as or larger than the cross-sectional area of the flow path of the second area 35 near a boundary between the first area 34 and the second area 35. If the cross-sectional area of the flow path near the boundary between the first area 34 and the second area 35 is smaller than the cross-sectional area of the flow path in the second area 35, since the thermocline becomes more gradual, an effect of an increased thermal energy storage amount and an increased thermal dissipation amount due to the steepening of the thermocline may decrease. In addition, when the thermal energy storage tank 1 includes n-number of types of the solid sensible heat storage materials 23, desirably, the cross-sectional area of the flow path of the first solid sensible heat storage material 19 is the same as or larger than the cross-sectional area of the flow path of the n-th area near a boundary between the first area 34 and the n-th area.

An incorporated amount of the first solid sensible heat storage material 19 is desirably set so that the fifth thermocline 36 is only present on the first area 34 at the end of a thermal dissipation operation. This is because, compared to the fifth thermocline 36 present on the first area 34 being steep when a thermocline is also present in an area other than the first area 34, since a thermocline not present on the first area 34 remains the third thermocline 29 that is not steep, the thermal energy storage amount and the thermal dissipation amount can be further increased by making all thermoclines steep. For example, the incorporated amount can be set based on an actual value obtained by temperature measurement or set by a numerical calculation.

In addition, while the thermal energy storage system 200 according to the present embodiment is configured to use dissipated heat as a heat source for the steam turbine 10, the thermal energy storage system 200 may also be used for air conditioning and other applications. The applications are the same in all subsequent embodiments.

According to the present embodiment, as described above, the thermal energy storage tank 1 incorporates a plurality of types of solid sensible heat storage materials 23, and the first solid sensible heat storage material 19 being the solid sensible heat storage material 23 incorporated nearest to the outlet side during a thermal dissipation operation is made a thermal energy storage material with a smaller particle size than the second solid sensible heat storage material. Accordingly, due to an increase in the surface area per unit volume of the thermal energy storage tank 1 and a larger gradient of the thermal energy storage temperature of the thermal energy storage tank 1, the thermal energy storage temperature in the first area 34 rises and increases both the thermal energy storage amount and the thermal dissipation amount, and a thermal dissipation operation time until the thermal dissipation operation-time allowable temperature 31 is reached can be increased.

In addition, whereas the pressure loss of the air 5 sufficiently increases when all of the thermal energy storage materials are replaced with the first solid sensible heat storage material 19, according to the present embodiment, only a part of the thermal energy storage materials is the first solid sensible heat storage material 19 and the other thermal energy storage materials are the second solid sensible heat storage material 18. Therefore, by suppressing the pressure loss of the thermal energy storage materials, the thermal energy storage amount and the thermal dissipation amount can be increased while suppressing a load on the blower and suppressing power consumption.

Furthermore, according to the present embodiment, a structure can be adopted such that the cross-sectional area of the flow path of the first solid sensible heat storage material 19 is the same as or larger than the cross-sectional area of the flow path of the second area 35 near a boundary between the first area 34 and the second area 35. Adopting such a structure enables the thermal energy storage tank 1 to prevent a gradient of a thermocline from becoming gradual. Accordingly, the thermal energy storage tank 1 can suppress the effect of respectively increasing the thermal energy storage amount and the thermal dissipation amount from becoming diminished and can increase the thermal dissipation operation time.

### Eighth Embodiment

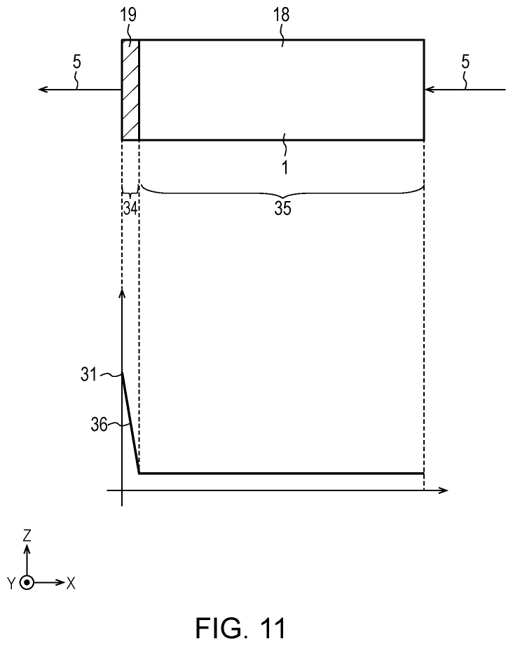

An eighth embodiment that corresponds to claims 12, 13, 14, and 21 will be described. FIG. 11 is a schematic view and a diagram showing a temperature distribution during a thermal dissipation operation of the thermal energy storage tank 1 according to the eighth embodiment.

Since an overall configuration diagram of the power conditioning system 100 including the thermal energy storage system 200 is similar to FIG. 18, a description thereof will not be repeated. An upper half of FIG. 11 shows a schematic view of the thermal energy storage tank 1 during a thermal energy storage operation and a lower half of FIG. 11 shows a temperature distribution of the thermal energy storage tank 1 during the thermal energy storage operation and temperatures at corresponding positions in the schematic view in the upper half.

Even in the present embodiment, a plurality of types of solid sensible heat storage materials 23 are incorporated in the thermal energy storage tank 1 in a similar manner to the seventh embodiment. While an example in which the thermal energy storage tank 1 incorporates two types of solid sensible heat storage materials 23 will be described in the present embodiment, the number of types of solid sensible heat storage materials 23 incorporated in the thermal energy storage tank 1 is not limited thereto. The thermal energy storage tank 1 may include any n-number of types (where n is an integer greater than or equal to 2) of solid sensible heat storage materials 23.

In the seventh embodiment, it was described that an incorporated amount of the first solid sensible heat storage material 19 is desirably set so that the fifth thermocline 36 is only present on the first area 34 at the end of a thermal dissipation operation. Since the first solid sensible heat storage material 19 is an object that increases pressure loss of the air 5 as compared to the second solid sensible heat storage material 18, a load on a blower (the first blower 3 during a thermal energy storage operation and the second blower 4 during a thermal dissipation operation) becomes large, resulting in high power consumption. In consideration thereof, desirably, an incorporated amount of the first solid sensible heat storage material 19 is reduced to reduce pressure loss.

Therefore, in the present embodiment, a temperature area that is not the fifth thermocline 36 is set so as not to be present on the first area 34 at the end of a thermal dissipation operation to minimize the first area 34.

While a thermocline at a time point where the first outflow air temperature 25 reaches the allowable temperature in the conventional technique is the fourth thermocline 30 as shown in FIG. 20, in the seventh embodiment, as shown in FIG. 10, a thermocline at a same time point is the fourth thermocline 30 in the second area 35 and the sixth thermocline 37 in the first area 34. The thermal energy storage temperature at this point is the second thermal energy storage temperature 51. Since the second outflow air temperature 52 has not dropped to the thermal dissipation operation-time allowable temperature 31, the thermal dissipation operation is not ended and is continued. Subsequently, while the second outflow air temperature 52 reaches the thermal dissipation operation-time allowable temperature 31, the thermocline at that point is the fifth thermocline 36.

In the eighth embodiment, an incorporated amount of the first solid sensible heat storage material 19 is reduced to the first area 34 that is a smallest area shown in the upper half of FIG. 11. As shown in the lower half of FIG. 11, a thermocline upon the second outflow air temperature 52 reaching the thermal dissipation operation-time allowable temperature 31 is the fifth thermocline 36 which is similar to the seventh embodiment. Therefore, the effect remains the same even if the incorporated amount of the first solid sensible heat storage material 19 is reduced to the smallest area.

Therefore, by setting the incorporated amount of the first solid sensible heat storage material 19 to “an incorporated amount such that, during a thermal dissipation operation, a temperature area that is not the thermocline present on a temperature distribution of solid sensible heat storage materials is not present on a temperature distribution of the first solid sensible heat storage material 19 at the end of the thermal dissipation operation”, a same effect as a case of a larger incorporated amount can be obtained and the incorporated amount of the first solid sensible heat storage material 19 can be reduced while satisfying the condition.

While the thermal energy storage tank 1 described in the seventh and eighth embodiments is configured such that the first solid sensible heat storage material 19 is incorporated in an area nearest to the outlet side during a thermal dissipation operation, as described in the first and second embodiments, a configuration may be adopted in which the first solid sensible heat storage material 19 is simultaneously incorporated in an area nearest to the outlet side during a thermal energy storage operation. In other words, the technique according to the first and second embodiments and the technique according to the seventh and eighth embodiments may be implemented at the same time.

According to the present embodiment, the thermal energy storage tank 1 sets a smallest area of the first solid sensible heat storage material 19 so that a temperature area that is not the fifth thermocline 36 is not present on the first area 34 at the end of a thermal dissipation operation. Accordingly, the thermal energy storage tank 1 can obtain a similar thermal energy storage amount, thermal dissipation amount, thermal dissipation time, and thermal dissipation temperature as the thermal energy storage tank 1 according to the seventh embodiment by reducing the incorporated amount of the first solid sensible heat storage material 19 while maintaining an effect of making a thermocline steep at a same level, suppressing pressure loss of the air 5 due to the thermal energy storage materials, and suppressing a load on the blower and suppressing power consumption. In other words, the power consumption by the blower can be minimized while maintaining the same improvement in terms of the thermal energy storage amount, the thermal dissipation amount, the thermal dissipation time, and the thermal dissipation temperature as in the seventh embodiment.

### Ninth Embodiment

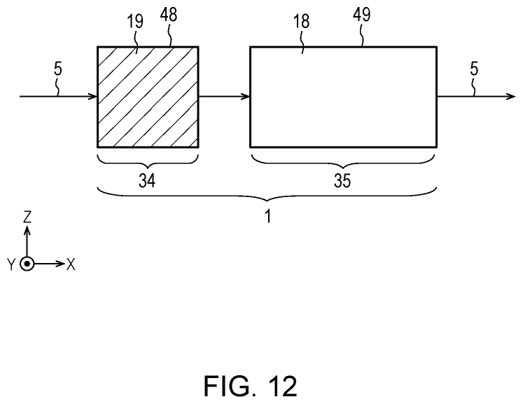

A ninth embodiment that corresponds to claims 15, 18, and 20 will be described. FIG. 12 shows a schematic view of a thermal energy storage tank according to the ninth embodiment.

Since an overall configuration diagram of the power conditioning system 100 including the thermal energy storage system 200 is similar to FIG. 18, a description thereof will not be repeated.

In the present embodiment, the thermal energy storage tank 1 is divided into a plurality of parts. In this example, the thermal energy storage tank 1 is divided into two parts. A thermal energy storage tank on a side into which the air 5 flows during a thermal energy storage operation will be referred to as the high temperature-side thermal energy storage tank 48 and a thermal energy storage tank on a side from which the air 5 flows out during the thermal energy storage operation will be referred to as the low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank into which the air 5 flows during a thermal energy storage operation will be referred to as the high temperature-side thermal energy storage tank 48 and other thermal energy storage tanks will be referred to as low temperature-side thermal energy storage tanks 49.

In addition, the thermal energy storage tank arranged most upstream during a thermal energy storage operation is also referred to as a first divided thermal energy storage tank and an m-th thermal energy storage tank on a downstream side as counted from the first divided thermal energy storage tank is also referred to as an m-th divided thermal energy storage tank. In this example, the high temperature-side thermal energy storage tank 48 corresponds to the first divided thermal energy storage tank and the low temperature-side thermal energy storage tank 49 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the example shown in FIG. 12, the high temperature-side thermal energy storage tank 48 incorporates the first solid sensible heat storage material 19 and the low temperature-side thermal energy storage tank 49 incorporates the second solid sensible heat storage material 18. In addition, while the first solid sensible heat storage material 19 is the only thermal energy storage material incorporated in the high temperature-side thermal energy storage tank 48 in the example shown in FIG. 12, only an inlet side into which the air 5 flows during a thermal energy storage operation may incorporate the first solid sensible heat storage material 19 and the second solid sensible heat storage material 18 may be incorporated further downstream inside the high temperature-side thermal energy storage tank 48. Each of the high temperature-side thermal energy storage tank 48 and the low temperature-side thermal energy storage tank 49 may incorporate a plurality of types of thermal energy storage materials. If only one type of thermal energy storage material is incorporated in each of the high temperature-side thermal energy storage tank 48 and the low temperature-side thermal energy storage tank 49, there is no need to provide partition plates in the thermal energy storage tanks, thereby enabling a simplified structure to be adopted and maintainability to be improved. In addition, while the thermal energy storage tank 1 uses the air 5 as a high-temperature heat source fluid in this example, another gas may be used or a liquid may be used instead of a gas. The air 5 is an example of a fluid that is a thermal medium.

Furthermore, when the high temperature-side thermal energy storage tank 48 includes n-number of types of solid sensible heat storage materials 23, the first solid sensible heat storage material 19 is a thermal energy storage material with a smaller particle size than an n-th solid sensible heat storage material arranged on a downstream side during a thermal energy storage operation.

In addition, desirably, the cross-sectional area of the flow path of the first solid sensible heat storage material 19 is the same as or larger than the cross-sectional area of the flow path of an n-th area near a boundary between the first area 34 and the n-th area.

Furthermore, when a plurality of types of the solid sensible heat storage materials 23 are to be incorporated in the high temperature-side thermal energy storage tank 48, the incorporated amount of the first solid sensible heat storage material 19 is desirably set so that the fifth thermocline 36 is only present on the first area 34 at the end of a thermal dissipation operation.

According to the present embodiment, due to an increase in the surface area per unit volume and, consequently, a thermocline becoming steeper in the first divided thermal energy storage tank, the thermal energy storage tank 1 can raise the thermal energy storage temperature in the first area 34, increase both the thermal energy storage amount and the thermal dissipation amount, and increase a thermal dissipation time. In addition, the thermal dissipation temperature can also be raised.

In addition, according to the present embodiment, when the incorporated amount of the first solid sensible heat storage material 19 is set so that a thermocline present on a temperature distribution of solid sensible heat storage materials during a thermal dissipation operation is only present on a temperature distribution of the second solid sensible heat storage material 18 at the end of the thermal dissipation operation in the first divided thermal energy storage tank, the thermal energy storage tank 1 can reduce pressure loss of the air 5 and reduce a load on the blower while keeping the thermocline steep.

In addition, whereas the pressure loss of the air 5 sufficiently increases when all of the thermal energy storage materials are replaced with the first solid sensible heat storage material 19, according to the present embodiment, only a part of the thermal energy storage materials is the first solid sensible heat storage material 19 and the other thermal energy storage materials are the second solid sensible heat storage material 18. Therefore, by suppressing the pressure loss of the thermal energy storage materials, the thermal energy storage amount, the thermal dissipation amount, the thermal dissipation time, and the thermal dissipation temperature can be improved while suppressing a load on the blower and suppressing power consumption.

### Tenth Embodiment

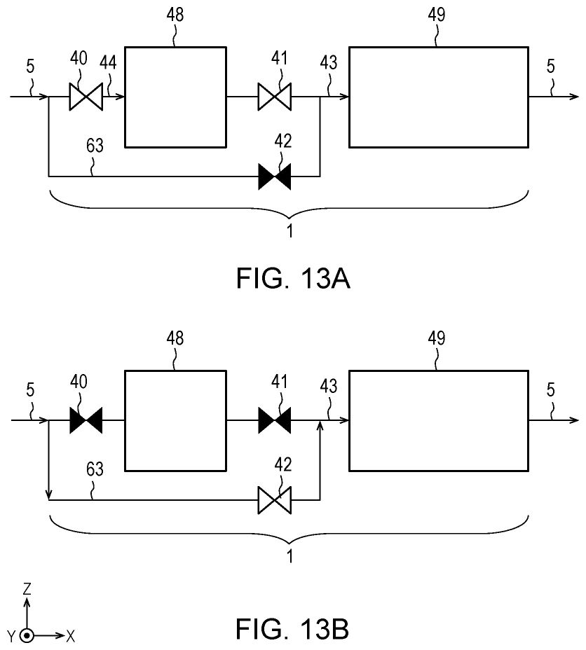

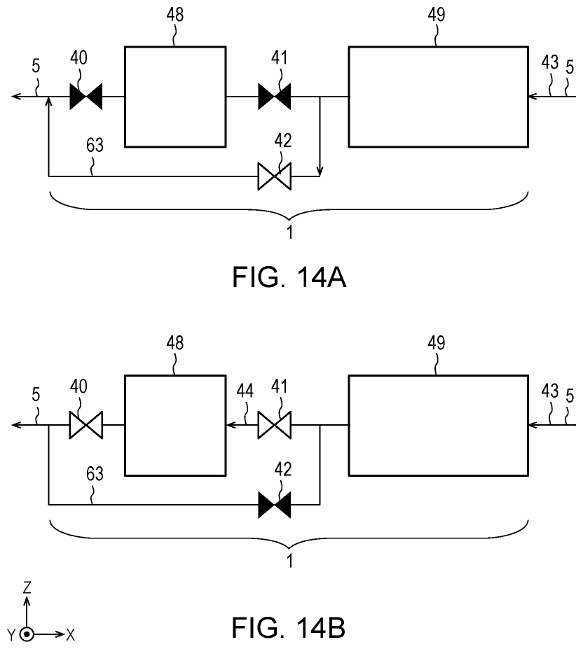

A tenth embodiment that corresponds to claims 15, 16, 18, and 20 will be described. FIG. 13 shows a schematic view during a thermal energy storage operation of the thermal energy storage tank 1 according to the tenth embodiment and FIG. 14 shows a schematic view during a thermal dissipation operation of the thermal energy storage tank 1 according to the tenth embodiment.

Since an overall configuration diagram of the power conditioning system 100 including the thermal energy storage system 200 is similar to FIG. 18, a description thereof will not be repeated.

In addition, in the present embodiment, the thermal energy storage tank 1 is divided into a plurality of parts in a similar manner to the embodiment described above. In this example, the thermal energy storage tank 1 is divided into two parts. A thermal energy storage tank on a side into which the air 5 flows during a thermal energy storage operation will be referred to as the high temperature-side thermal energy storage tank 48 and a thermal energy storage tank on a side from which the air 5 flows out during the thermal energy storage operation will be referred to as the low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank into which the air 5 flows during a thermal energy storage operation will be referred to as the high temperature-side thermal energy storage tank 48 and other thermal energy storage tanks will be referred to as low temperature-side thermal energy storage tanks 49.

In addition, the thermal energy storage tank arranged most upstream during a thermal energy storage operation is also referred to as a first divided thermal energy storage tank and an m-th thermal energy storage tank on a downstream side as counted from the first divided thermal energy storage tank is also referred to as an m-th divided thermal energy storage tank. In this example, the high temperature-side thermal energy storage tank 48 corresponds to the first divided thermal energy storage tank and the low temperature-side thermal energy storage tank 49 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the present embodiment, the high temperature-side thermal energy storage tank 48 incorporates the first solid sensible heat storage material 19 and the low temperature-side thermal energy storage tank 49 incorporates the second solid sensible heat storage material 18 in a similar manner to the ninth embodiment. In addition, while the first solid sensible heat storage material 19 is the only thermal energy storage material incorporated in the high temperature-side thermal energy storage tank 48 in the example shown in FIG. 13, a plurality of types of heat storage materials may be used such as only an inlet side into which the air 5 flows during a thermal energy storage operation incorporating the first solid sensible heat storage material 19 and the second solid sensible heat storage material 18 being incorporated further downstream inside the high temperature-side thermal energy storage tank 48.

Furthermore, when the high temperature-side thermal energy storage tank 48 includes n-number of types of solid sensible heat storage materials 23, the first solid sensible heat storage material 19 is a thermal energy storage material with a smaller particle size than an n-th solid sensible heat storage material arranged on a downstream side during a thermal energy storage operation.

In addition, desirably, a structure is adopted such that the cross-sectional area of the flow path of the first solid sensible heat storage material 19 is the same as or larger than the cross-sectional area of the flow path of an n-th area near a boundary between the first area 34 and the n-th area.

When the high temperature-side thermal energy storage tank 48 incorporates a plurality of types of the solid sensible heat storage materials 23, the incorporated amount of the first solid sensible heat storage material 19 is desirably set so that the fifth thermocline 36 is only present on the first area 34 at the end of a thermal dissipation operation.

In the embodiment described above, it was described that due to the thermal energy storage tank 1 incorporating the first solid sensible heat storage material 19, the thermal energy storage temperature rises in the first area 34, both the thermal energy storage amount and the thermal dissipation amount can be increased, and the thermal dissipation time can be increased. On the other hand, pressure loss is desirably suppressed in the first area 34 since a large pressure loss of a flow of the air 5 causes power consumption by the blower to increase during a thermal energy storage operation or a thermal dissipation operation. Therefore, as shown in FIG. 13, the thermal energy storage tank 1 according to the present embodiment is equipped with the high temperature-side bypass flow path 63 that bypasses the high temperature-side thermal energy storage tank 48 and valves 40 to 42. In addition, in FIG. 13, each of the valves 40 to 42 shown in white indicates being in an “open” state and each of the valves 40 to 42 shown in black indicates being in a “closed” state. When the thermal energy storage tank 1 includes the m-th divided thermal energy storage tank, the high temperature-side bypass flow path 63 is connected so as to bypass the first divided thermal energy storage tank (in other words, the high temperature-side thermal energy storage tank 48).

While the valves are configured in this example so that one valve is provided at the outlet and the inlet, respectively, during a thermal energy storage operation in the high temperature-side thermal energy storage tank 48 and one valve is arranged in the high temperature-side bypass flow path 63, the number of valves is not limited thereto. The thermal energy storage tank 1 need only be equipped with one or more valves that switch between a flow path of the air 5 to the side of the high temperature-side thermal energy storage tank 48 and a flow path of the air 5 to the side of the high temperature-side bypass flow path 63.

At the start of a thermal energy storage operation, as shown in FIG. 13A, the thermal energy storage tank 1 opens the valve 40 and the valve 41 and closes the valve 42. After flowing in the high temperature-side thermal energy storage tank 48 as high temperature-side thermal energy storage tank inflow air 44, the air 5 flows in the low temperature-side thermal energy storage tank 49 as low temperature-side thermal energy storage tank inflow air 43. Once the thermal energy storage operation proceeds and a thermocline (a thermocline that is steeper than the first thermocline 26 according to the conventional technique) finishes moving to the low temperature-side thermal energy storage tank 49, as shown in FIG. 13B, the thermal energy storage tank 1 closes the valves 40 and 41 and opens the valve 42. The air 5 flows through the high temperature-side bypass flow path 63 without flowing into the high temperature-side thermal energy storage tank 48. Subsequently, the air 5 flows in the low temperature-side thermal energy storage tank 49 as low temperature-side thermal energy storage tank inflow air 43. The second solid sensible heat storage material 18 in the low temperature-side thermal energy storage tank 49 is heated, a thermocline changes to the first thermocline 26 and advances toward the downstream side and, subsequently, the outlet temperature reaches the thermal energy storage operation-time allowable temperature 28 and the thermal energy storage operation ends.

Since an opening/closing timing of each valve when the thermocline moves to the low temperature-side thermal energy storage tank 49 can be calculated and determined from a start time point of the thermal energy storage operation, the opening/closing timing may be calculated and determined in such a manner or a temperature sensor may be installed near an outlet of the high temperature-side thermal energy storage tank 48 or the like and a time point where the temperature provided by the temperature sensor reaches a temperature set in advance may be adopted. In addition, control of each valve may be implemented manually by an operator or implemented automatically using information from a sensor or a timer.

At the start of a thermal dissipation operation, as shown in FIG. 14A, the thermal energy storage tank 1 closes the valves 40 and 41 and opens the valve 42. After flowing in the low temperature-side thermal energy storage tank 49 as low temperature-side thermal energy storage tank inflow air 43, the air 5 flows through the high temperature-side bypass flow path 63 without flowing into the high temperature-side thermal energy storage tank 48. Once the thermal dissipation operation proceeds and the third thermocline 29 is ready to move to the inlet of the high temperature-side thermal energy storage tank 48, as shown in FIG. 14B, the thermal energy storage tank 1 opens the valves 40 and 41 and closes the valve 42. After flowing in the low temperature-side thermal energy storage tank 49 as low temperature-side thermal energy storage tank inflow air 43, the air 5 flows in the high temperature-side thermal energy storage tank 48 as high temperature-side thermal energy storage tank inflow air 44. Subsequently, the second outflow air temperature 52 reaches the thermal dissipation operation-time allowable temperature 31 and the thermal dissipation operation ends.

Since an opening/closing timing of each valve when the third thermocline 29 moves to the high temperature-side thermal energy storage tank 48 can be calculated and determined from a start time point of the thermal dissipation operation, the opening/closing timing may be calculated and determined in such a manner or a temperature sensor may be installed near an outlet of the low temperature-side thermal energy storage tank 49 or the like and a time point where the temperature provided by the temperature sensor reaches a temperature set in advance may be adopted. In addition, control of each valve may be implemented manually by an operator or implemented automatically using information from a sensor or a timer.

While the thermal energy storage tank 1 described in the tenth embodiment, divided in plurality, and equipped with the high temperature-side bypass flow path 63 is configured such that the first solid sensible heat storage material 19 is incorporated in an area nearest to the outlet side during a thermal dissipation operation, as described in the fourth embodiment, a configuration may be adopted in which the first solid sensible heat storage material 19 is simultaneously incorporated in an area nearest to the outlet side during a thermal energy storage operation. In other words, the technique according to the fourth embodiment and the technique according to the tenth embodiment may be implemented at the same time.

According to the present embodiment, when the high temperature-side thermal energy storage tank 48 is bypassed during a thermal energy storage operation and a thermal dissipation operation of the thermal energy storage tank 1, the air 5 does not flow to the first solid sensible heat storage material 19 that increases pressure loss. Therefore, pressure loss due to the first solid sensible heat storage material 19 can be reduced to zero.

Accordingly, in addition to the effect of being able to increase the thermal energy storage temperature, the thermal energy storage amount, the thermal dissipation amount, and the thermal dissipation time, the thermal energy storage tank 1 can further suppress a load on the blower and suppress power consumption by suppressing pressure loss in the flow of the air 5 during the thermal energy storage operation and the thermal dissipation operation.

### Eleventh Embodiment

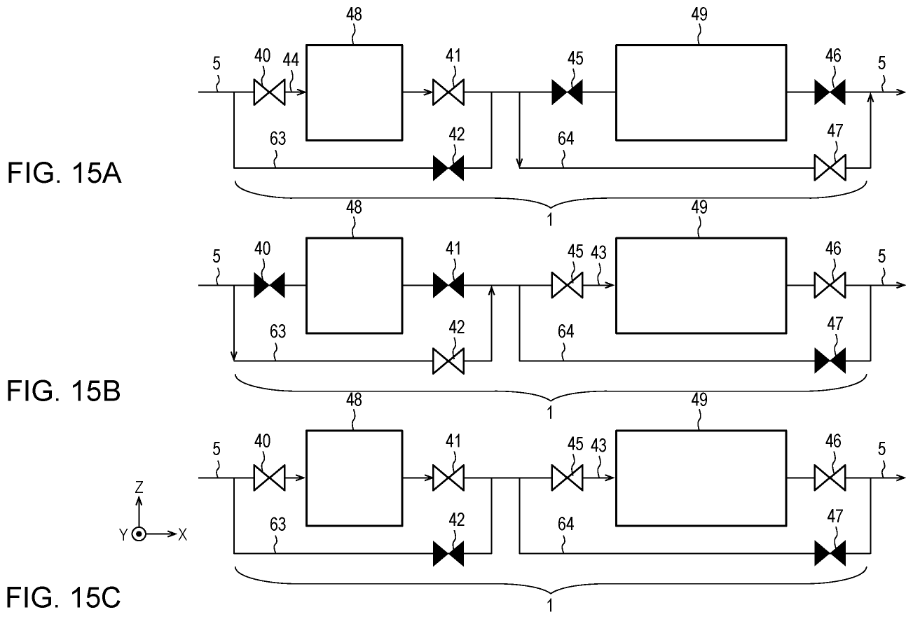

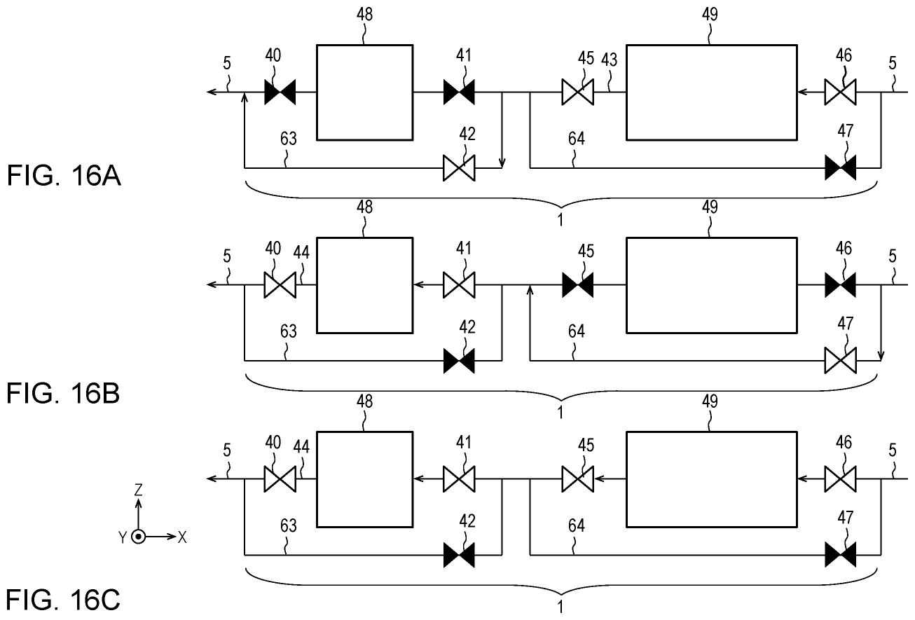

An eleventh embodiment that corresponds to claims 15, 16, 17, 18, and 20 will be described. FIG. 15 shows a schematic view during a thermal energy storage operation of the thermal energy storage tank 1 according to the eleventh embodiment and FIG. 16 shows a schematic view during a thermal dissipation operation of the thermal energy storage tank 1 according to the eleventh embodiment.

Since an overall configuration diagram of the power conditioning system 100 including the thermal energy storage system 200 is similar to FIG. 18, a description thereof will not be repeated.

In addition, in the present embodiment, the thermal energy storage tank 1 is divided into a plurality of parts in a similar manner to the embodiment described above. In this example, the thermal energy storage tank 1 is divided into two parts. A thermal energy storage tank on a side into which the air 5 flows during a thermal energy storage operation will be referred to as the high temperature-side thermal energy storage tank 48 and a thermal energy storage tank on a side from which the air 5 flows out during the thermal energy storage operation will be referred to as the low temperature-side thermal energy storage tank 49. The number of divisions of the thermal energy storage tank 1 is not limited to two. The thermal energy storage tank 1 can include any m-number (where m is an integer greater than or equal to 2) of thermal energy storage tanks. In this case, a thermal energy storage tank into which the air 5 flows during a thermal energy storage operation will be referred to as the high temperature-side thermal energy storage tank 48 and other thermal energy storage tanks will be referred to as low temperature-side thermal energy storage tanks 49.

In addition, the thermal energy storage tank arranged most upstream during a thermal energy storage operation is also referred to as a first divided thermal energy storage tank and an m-th thermal energy storage tank on a downstream side as counted from the first divided thermal energy storage tank is also referred to as an m-th divided thermal energy storage tank. In this example, the high temperature-side thermal energy storage tank 48 corresponds to the first divided thermal energy storage tank and the low temperature-side thermal energy storage tank 49 corresponds to the second divided thermal energy storage tank. The first divided thermal energy storage tank and the second divided thermal energy storage tank are connected in series with each other. The first to m-th divided thermal energy storage tanks are similarly connected in series with each other.

Furthermore, in the present embodiment, the high temperature-side thermal energy storage tank 48 incorporates the first solid sensible heat storage material 19 and the low temperature-side thermal energy storage tank 49 incorporates the second solid sensible heat storage material 18 in a similar manner to the ninth embodiment. In addition, while the first solid sensible heat storage material 19 is the only thermal energy storage material incorporated in the high temperature-side thermal energy storage tank 48 in the example shown in FIG. 18, only an inlet side into which the air 5 flows during a thermal energy storage operation may incorporate the first solid sensible heat storage material 19 and the second solid sensible heat storage material 18 may be incorporated further downstream inside the high temperature-side thermal energy storage tank 48. Each of the high temperature-side thermal energy storage tank 48 and the low temperature-side thermal energy storage tank 49 may incorporate a plurality of types of thermal energy storage materials.

Furthermore, when the high temperature-side thermal energy storage tank 48 includes n-number of types of solid sensible heat storage materials 23, the first solid sensible heat storage material 19 is a thermal energy storage material with a smaller particle size than an n-th solid sensible heat storage material arranged on a downstream side during a thermal energy storage operation.

In addition, desirably, a structure is adopted such that the cross-sectional area of the flow path of the first solid sensible heat storage material 19 is the same as or larger than the cross-sectional area of the flow path of an n-th area near a boundary between the first area 34 and the n-th area.

In the tenth embodiment described above, it was described that due to the thermal energy storage tank 1 incorporating the first solid sensible heat storage material 19, the thermal energy storage temperature rises in the first area 34, both the thermal energy storage amount and the thermal dissipation amount can be increased, and the thermal dissipation time can be increased. On the other hand, since pressure loss due to the second solid sensible heat storage material 18 is not suppressed when the air 5 flows in the low temperature-side thermal energy storage tank 49 in the tenth embodiment, a total pressure loss of the high temperature-side thermal energy storage tank 48 and the low temperature-side thermal energy storage tank 49 is large even if the pressure loss of the low temperature-side thermal energy storage tank 49 is suppressed and, desirably, the total pressure loss is also suppressed. Therefore, as shown in FIG. 15, the thermal energy storage tank 1 according to the present embodiment is equipped with the low temperature-side bypass flow path 64 that bypasses the low temperature-side thermal energy storage tank 49 and valves 45 to 47. When the thermal energy storage tank 1 includes the m-th divided thermal energy storage tank, the low temperature-side bypass flow path 64 is connected so as to bypass second to m-th divided thermal energy storage tanks (in other words, the entire low temperature-side thermal energy storage tank 49). In addition, one or more low temperature-side bypass flow paths 64 may be connected so as to divide each of the second to m-th divided thermal energy storage tanks.

While the valves are configured in this example so that one valve is provided at the outlet and the inlet, respectively, during a thermal energy storage operation in the high temperature-side thermal energy storage tank 48 and one valve is arranged in the high temperature-side bypass flow path 63, the number of valves is not limited thereto. The thermal energy storage tank 1 need only be equipped with one or more valves that switch between a flow path of the air 5 to the side of the high temperature-side thermal energy storage tank 48 and a flow path of the air 5 to the side of the high temperature-side bypass flow path 63.

While the valves are configured in this example so that one valve is provided at the outlet and the inlet, respectively, during a thermal energy storage operation in the low temperature-side thermal energy storage tank 49 and one valve is arranged in the low temperature-side bypass flow path 64, the number of valves is not limited thereto. The thermal energy storage tank 1 need only be equipped with one or more valves that switch between a flow path of the air 5 to the side of the low temperature-side thermal energy storage tank 49 and a flow path of the air 5 to the side of the low temperature-side bypass flow path 64.

At the start of a thermal energy storage operation, as shown in FIG. 15A, the thermal energy storage tank 1 opens the valves 40 and 41 and closes the valve 42. In addition, the thermal energy storage tank 1 closes the valves 45 and 46 and opens the valve 47. After flowing in the high temperature-side thermal energy storage tank 48 as high temperature-side thermal energy storage tank inflow air 44, the air 5 flows through the low temperature-side bypass flow path 64 without flowing into the low temperature-side thermal energy storage tank 49. Once the first solid sensible heat storage material 19 in the high temperature-side thermal energy storage tank 48 is heated and a thermocline moves to the low temperature-side thermal energy storage tank 49, via a state shown in FIG. 15C to be described later, the thermal energy storage tank 1 closes the valves 40, 41, and 47 and opens the valves 42, 45, and 46 as shown in FIG. 15B. The air 5 flows through the high temperature-side bypass flow path 63 without flowing into the high temperature-side thermal energy storage tank 48 and flows in the low temperature-side thermal energy storage tank 49 as low temperature-side thermal energy storage tank inflow air 43 without flowing into the low temperature-side bypass flow path 64. The second solid sensible heat storage material 18 in the low temperature-side thermal energy storage tank 49 is heated, the thermocline changes to the first thermocline 26 and advances toward the downstream side and, subsequently, the outlet temperature reaches the thermal energy storage operation-time allowable temperature 28 and the thermal energy storage operation ends.

Since the thermocline is inclined, as shown in FIG. 15C, when the thermocline reaches the outlet of the high temperature-side thermal energy storage tank 48 after the start of a thermal energy storage operation, the valves 40, 41, 45, and 46 are opened and the valves 42 and 47 are closed to cause the air 5 to flow in both the high temperature-side thermal energy storage tank 48 and the low temperature-side thermal energy storage tank 49. At this point, the thermocline is present near the outlet of the high temperature-side thermal energy storage tank 48 and near the inlet of the low temperature-side thermal energy storage tank 49. Subsequently, once the thermocline finishes passing through the outlet of the high temperature-side thermal energy storage tank 48, the valve 42 is closed and the valves 40 and 41 are opened to cause the air 5 to flow in the high temperature-side bypass flow path 63 and the low temperature-side thermal energy storage tank 49.

Since an opening/closing timing of each valve when the first thermocline 26 moves to the low temperature-side thermal energy storage tank 49 can be calculated and determined from a start time point of the thermal energy storage operation of the high temperature-side thermal energy storage tank 48, the opening/closing timing may be calculated and determined in such a manner or a temperature sensor may be installed near an outlet of the high temperature-side thermal energy storage tank 48 or the like and a time point where the temperature provided by the temperature sensor reaches a temperature set in advance may be adopted. In addition, control of each valve may be implemented manually by an operator or implemented automatically using information from a sensor or a timer.

At the start of a thermal dissipation operation, as shown in FIG. 16A, the thermal energy storage tank 1 closes the valves 40 and 41 and opens the valve 42. In addition, the thermal energy storage tank 1 opens the valves 45 and 46 and closes the valve 47. After flowing in the low temperature-side thermal energy storage tank 49 as low temperature-side thermal energy storage tank inflow air 43, the air 5 flows through the high temperature-side bypass flow path 63 without flowing into the high temperature-side thermal energy storage tank 48. Once the thermal dissipation operation proceeds and the third thermocline 29 moves to the high temperature-side thermal energy storage tank 48, as shown in FIG. 16B, the thermal energy storage tank 1 opens the valves 40 and 41 and closes the valve 42. In addition, the thermal energy storage tank 1 closes the valves 45 and 46 and opens the valve 47. After flowing through the low temperature-side bypass flow path 64 without flowing into the low temperature-side thermal energy storage tank 49, the air 5 flows in the high temperature-side thermal energy storage tank 48 as high temperature-side thermal energy storage tank inflow air 44. Subsequently, the second outflow air temperature 52 reaches the thermal dissipation operation-time allowable temperature 31 and the thermal dissipation operation ends.

Since the third thermocline 29 is inclined, as shown in FIG. 16C, when the third thermocline 29 reaches the outlet of the low temperature-side thermal energy storage tank 49 after the start of a thermal energy storage operation, the valves 40, 41, 45, and 46 are opened and the valves 42 and 47 are closed to cause the air 5 to flow in both the low temperature-side thermal energy storage tank 49 and the high temperature-side thermal energy storage tank 48. At this point, the third thermocline 29 is present near the outlet of the low temperature-side thermal energy storage tank 49 and near the inlet of the high temperature-side thermal energy storage tank 48. Subsequently, once the third thermocline 29 finishes passing through the outlet of the low temperature-side thermal energy storage tank 49, the valves 45 and 46 are closed and the valve 47 is opened to cause the air 5 to flow in the low temperature-side bypass flow path 64 and the high temperature-side thermal energy storage tank 48.

Since an opening/closing timing of each valve when the third thermocline 29 moves to the high temperature-side thermal energy storage tank 48 can be calculated and determined from a start time point of the thermal dissipation operation, the opening/closing timing may be calculated and determined in such a manner or a temperature sensor may be installed near an outlet of the low temperature-side thermal energy storage tank 49 or the like and a time point where the temperature provided by the temperature sensor reaches a temperature set in advance may be adopted. In addition, control of each valve may be implemented manually by an operator or implemented automatically using information from a sensor or a timer.

While the thermal energy storage tank 1 described in the eleventh embodiment, divided in plurality, and equipped with the low temperature-side bypass flow path 64 and the high temperature-side bypass flow path 63 is configured such that the first solid sensible heat storage material 19 is incorporated in an area nearest to the outlet side during a thermal dissipation operation, as described in the fifth embodiment, a configuration may be adopted in which the first solid sensible heat storage material 19 is simultaneously incorporated in an area nearest to the outlet side during a thermal energy storage operation. In other words, the technique according to the fifth embodiment and the technique according to the eleventh embodiment may be implemented at the same time.

According to the present embodiment, the thermal energy storage tank 1 is equipped with the high temperature-side bypass flow path 63, and when the high temperature-side thermal energy storage tank 48 is bypassed during a thermal energy storage operation and a thermal dissipation operation, the air 5 does not flow to the first solid sensible heat storage material 19 that increases pressure loss. Therefore, pressure loss due to the first solid sensible heat storage material 19 can be reduced to zero. As a result, when the air 5 does not flow in the high temperature-side thermal energy storage tank 48, a total pressure loss of the high temperature-side thermal energy storage tank 48 and the low temperature-side thermal energy storage tank 49 is not only smaller as compared to a case not provided with each bypass flow path as in the ninth embodiment but also smaller as compared to a case only provided with the low temperature-side bypass flow path 64 as in the tenth embodiment. Accordingly, in addition to the effect of increasing the thermal energy storage temperature, the thermal energy storage amount, the thermal dissipation amount, and the thermal dissipation time, the thermal energy storage tank 1 can further suppress a load on the blower and suppress power consumption by suppressing pressure loss due to the first solid sensible heat storage material 19 in the flow of the air 5 during the thermal energy storage operation and the thermal dissipation operation.

In addition, according to the present embodiment, the thermal energy storage tank 1 is equipped with the low temperature-side bypass flow path 64, and when the low temperature-side thermal energy storage tank 49 is bypassed during a thermal energy storage operation and a thermal dissipation operation, the air 5 does not flow to the second solid sensible heat storage material 18. Therefore, pressure loss due to the second solid sensible heat storage material 18 can be reduced to zero. As a result, even when the air 5 does not flow in the low temperature-side thermal energy storage tank 49, a total pressure loss of the high temperature-side thermal energy storage tank 48 and the low temperature-side thermal energy storage tank 49 is smaller as compared to a case not provided with each bypass flow path as in the ninth embodiment. Accordingly, the thermal energy storage tank 1 can increase the thermal energy storage temperature, the thermal energy storage amount, the thermal dissipation amount, and the thermal dissipation time and, further, the thermal energy storage tank 1 can suppress pressure loss due to the second solid sensible heat storage material 18 in the flow of the air 5 during the thermal energy storage operation and the thermal dissipation operation.

### Twelfth Embodiment

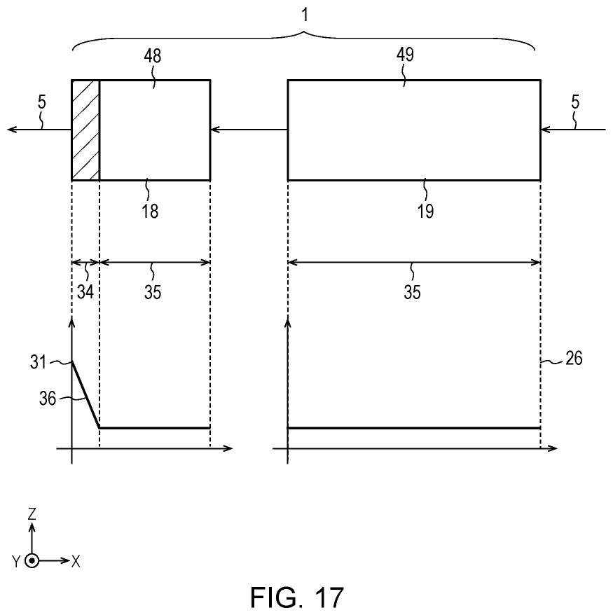

A twelfth embodiment that corresponds to claims 15, 16, 17, 18, 19, and 22 will be described. FIG. 17 is a schematic view and a diagram showing a temperature distribution during a thermal dissipation operation of the thermal energy storage tank 1 according to the twelfth embodiment.

Since an overall configuration diagram of the power conditioning system 100 including the thermal energy storage system 200 is similar to FIG. 18, a description thereof will not be repeated. An upper half of FIG. 17 shows a schematic view of the thermal energy storage tank 1 during a thermal energy storage operation and a lower half of FIG. 17 shows a temperature distribution of the thermal energy storage tank 1 during the thermal energy storage operation and temperatures at corresponding positions in the schematic view in the upper half.

Even in the present embodiment, a plurality of types of solid sensible heat storage materials 23 are incorporated in the thermal energy storage tank 1 in a similar manner to the seventh embodiment. While an example in which the thermal energy storage tank 1 incorporates two types of solid sensible heat storage materials 23 will be described in the present embodiment, the number of types of solid sensible heat storage materials 23 incorporated in the thermal energy storage tank 1 is not limited thereto. The thermal energy storage tank 1 may include any n-number of types (where n is an integer greater than or equal to 2) of solid sensible heat storage materials 23.

In the ninth embodiment, it was described that an incorporated amount of the first solid sensible heat storage material 19 is desirably set so that the fifth thermocline 36 is only present on the first area 34 at the end of a thermal dissipation operation. Since the first solid sensible heat storage material 19 is an object that increases pressure loss of the air 5 as compared to the second solid sensible heat storage material 18, a load on a blower (the first blower 3 during a thermal energy storage operation and the second blower 4 during a thermal dissipation operation) becomes large, resulting in high power consumption. In consideration thereof, desirably, an incorporated amount of the first solid sensible heat storage material 19 is reduced to reduce pressure loss.

Therefore, in the present embodiment, the first area 34 is set so that the fifth thermocline 36 is only present on the first area 34 at the end of a thermal dissipation operation. Furthermore, in the present embodiment, a temperature area that is not the fifth thermocline 36 is set so as not to be present on the first area 34 at the end of a thermal dissipation operation to minimize the first area 34.

In the twelfth embodiment, an incorporated amount of the first solid sensible heat storage material 19 is reduced to the first area 34 that is a smallest area shown in the upper half of FIG. 17. As shown in the lower half of FIG. 17, a thermocline at a point where the second outflow air temperature 52 reaches the thermal dissipation operation-time allowable temperature 31 is the fifth thermocline 36 which is similar to the ninth embodiment. Therefore, the effect remains the same even if the incorporated amount of the first solid sensible heat storage material 19 is reduced to the smallest area. The technique according to the present embodiment can be applied to the ninth to eleventh embodiments. While the thermal energy storage material incorporated in the high temperature-side thermal energy storage tank 48 is only the first solid sensible heat storage material 19 in the example shown in FIG. 12, in this case, a size of the thermal energy storage tank 48 is determined so that an incorporated amount of the first solid sensible heat storage material 19 prevents a temperature area that is not the fifth thermocline 36 from being present on the first area 34 at the end of a thermal dissipation operation.

Therefore, by setting the incorporated amount of the first solid sensible heat storage material 19 to “an incorporated amount such that, during a thermal dissipation operation, a thermocline present on a temperature distribution of solid sensible heat storage materials is only present on a temperature distribution of the first solid sensible heat storage material 19 at the end of the thermal dissipation operation”, a same effect as a case of a larger incorporated amount can be obtained and the incorporated amount of the first solid sensible heat storage material 19 can be reduced while satisfying the condition.

In addition, even the thermal energy storage tank 1 described in the tenth and eleventh embodiments can be configured in a similar manner to the thermal energy storage tank 1 described in the present embodiment. In other words, even when the thermal energy storage tank 1 is equipped with the high temperature-side bypass flow path 63 and the low temperature-side bypass flow path 64, a similar effect to the present embodiment can be produced by setting the incorporated amount of the first solid sensible heat storage material 19 so that the fifth thermocline 36 is only present on the first area 34 at the end of a thermal dissipation operation.

While the thermal energy storage tank 1 divided in plurality and described in the ninth and twelfth embodiments is configured such that the first solid sensible heat storage material 19 is incorporated in an area nearest to the outlet side during a thermal dissipation operation, as described in the third and sixth embodiments, a configuration may be adopted in which the first solid sensible heat storage material 19 is simultaneously incorporated in an area nearest to the outlet side during a thermal energy storage operation. In other words, the technique according to the third and sixth embodiments and the technique according to the ninth and twelfth embodiments may be implemented at the same time.

According to the present embodiment, the thermal energy storage tank 1 sets a smallest area of the first solid sensible heat storage material 19 so that a temperature area that is not the fifth thermocline 36 is not present on the first area 34 at the end of a thermal dissipation operation. Accordingly, the thermal energy storage tank 1 can obtain a similar thermal energy storage amount, thermal dissipation amount, thermal dissipation time, and thermal dissipation temperature as the thermal energy storage tank 1 according to the ninth embodiment by reducing the incorporated amount of the first solid sensible heat storage material 19 while maintaining an effect of making a thermocline steep at a same level, suppressing pressure loss of the air 5 due to the thermal energy storage materials, and suppressing a load on the blower and suppressing power consumption. In other words, the power consumption by the blower can be minimized while maintaining the same improvement in terms of the thermal energy storage amount, the thermal dissipation amount, the thermal dissipation time, and the thermal dissipation temperature as in the ninth embodiment. While the fifth thermocline 36 is desirably set so as to be present only on the first area 34 when setting the incorporated amount of the first solid sensible heat storage material 19 so that a temperature area that is not the fifth thermocline 36 is not present in the first area 34 at the end of a thermal energy storage operation, when a reduction in power consumption due to a reduction in pressure loss is to be prioritized over maximizing an effect of increasing a thermal energy storage amount, the temperature area that is not the fifth thermocline 36 may be set so as not to be present on the first area 34 at the end of a thermal energy storage operation while causing the fifth thermocline 36 to be present on other than the first area 34.

While certain embodiments have been described above, these embodiments have been presented by way of example only and are not intended to limit the scope of the inventions. The novel thermal energy storage tank 1 described in the present specification can be implemented in various other modes. In addition, various omissions, substitutions, and modifications can be made to the modes of the thermal energy storage tank 1 described in the present specification to the extent that they do not depart from the gist of the invention. The appended claims and their equivalents are intended to include such modes and modifications included in the scope and gist of the invention.

1. A thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation, wherein
the first solid sensible heat storage material
is incorporated into a first area that is nearest to an outlet of the fluid during the thermal energy storage operation, and
has a smaller particle size than the n-th solid sensible heat storage material.

2. The thermal energy storage tank of claim 1, wherein an incorporated amount of the first solid sensible heat storage material is set so that a thermocline created inside the thermal energy storage tank is only present in the first area at an end of a thermal energy storage operation.

3. The thermal energy storage tank of claim 1, wherein an incorporated amount of the first solid sensible heat storage material is set so that a temperature area that is not a thermocline created inside the thermal energy storage tank is not present in the first area at an end of a thermal energy storage operation.

4. The thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation, wherein
the thermal energy storage tank includes first to m-th divided thermal energy storage tanks (where m is an integer greater than or equal to 2) that are connected in series,
the first solid sensible heat storage material
is incorporated into a first area that is nearest to an outlet of the first divided thermal energy storage tank arranged on a most downstream side of the fluid during a thermal energy storage operation, and
has a particle size smaller than the n-th solid sensible heat storage material that is arranged on an upstream side of the fluid during a thermal energy storage operation than the first divided thermal energy storage tank.

5. The thermal energy storage tank of claim 4, further comprising:
a low temperature-side bypass flow path configured to bypass the first divided thermal energy storage tank; and
one or more low temperature-side bypass valves configured to switch between a flow of the fluid to a side of the first divided thermal energy storage tank and a flow of the fluid to a side of the low temperature-side bypass flow path.

6. The thermal energy storage tank of claim 5, further comprising:
one or more high temperature-side bypass flow paths configured to bypass the second to m-th divided thermal energy storage tanks; and
one or more high temperature-side bypass valves configured to switch between a flow of the fluid to a side of the second to m-th divided thermal energy storage tanks and a flow of the fluid to a side of one or more the high temperature-side bypass flow paths.

7. The thermal energy storage tank of claim 4, wherein an incorporated amount of the first solid sensible heat storage material is set so that a thermocline created inside the thermal energy storage tank is only present in the first area at an end of a thermal energy storage operation.

8. The thermal energy storage tank of claim 4, wherein an incorporated amount of the first solid sensible heat storage material is set so that a temperature area that is not a thermocline created inside the thermal energy storage tank is not present in the first area at an end of a thermal energy storage operation.

9. The thermal energy storage tank of any one of claim 1, wherein
a cross-sectional area of a flow path in the first area
is the same as a cross-sectional area of a flow path of an n-th solid sensible heat storage material incorporated in an n-th area on an upstream side of the fluid during a thermal energy storage operation than the first area or
larger than the cross-sectional area of a flow path of the n-th solid sensible heat storage material.

10. The thermal energy storage tank of claim 3, wherein
a cross-sectional area of a flow path in the first area
is the same as a cross-sectional area of a flow path of an n-th solid sensible heat storage material incorporated in an n-th area on an upstream side of the fluid during a thermal energy storage operation than the first area or
larger than the cross-sectional area of a flow path of the n-th solid sensible heat storage material.

11. The thermal energy storage tank of claim 8, wherein
a cross-sectional area of a flow path in the first area
is the same as a cross-sectional area of a flow path of an n-th solid sensible heat storage material incorporated in an n-th area on an upstream side of the fluid during a thermal energy storage operation than the first area or
larger than the cross-sectional area of a flow path of the n-th solid sensible heat storage material.

12. A thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation, wherein
the first solid sensible heat storage material
is incorporated into a first area that is nearest to an outlet of the fluid during the thermal dissipation operation, and
has a smaller particle size than the n-th solid sensible heat storage material.

13. The thermal energy storage tank of claim 12, wherein an incorporated amount of the first solid sensible heat storage material is set so that a thermocline created inside the thermal energy storage tank is only present in the first area at an end of a thermal dissipation operation.

14. The thermal energy storage tank of claim 12, wherein an incorporated amount of the first solid sensible heat storage material is set so that a temperature area that is not a thermocline created inside the thermal energy storage tank is not present in the first area at an end of a thermal dissipation operation.

15. A thermal energy storage tank that stores heat by causing heat held by a fluid to be absorbed by first to n-th solid sensible heat storage materials (where n is an integer greater than or equal to 2) during a thermal energy storage operation and that dissipates heat by causing heat held by the first to n-th solid sensible heat storage materials to be absorbed by the fluid during a thermal dissipation operation, wherein
the thermal energy storage tank includes first to m-th divided thermal energy storage tanks (where m is an integer greater than or equal to 2) that are connected in series,
the first solid sensible heat storage material
is incorporated into a first area that is nearest to an outlet of the first divided thermal energy storage tank arranged on a most downstream side of the fluid during a thermal dissipation operation, and
has a particle size smaller than the n-th solid sensible heat storage material that is arranged on an upstream side of the fluid during a thermal dissipation operation than the first divided thermal energy storage tank.

16. The thermal energy storage tank of claim 15, further comprising:
a high temperature-side bypass flow path configured to bypass the first divided thermal energy storage tank; and
one or more high temperature-side bypass valves configured to switch between a flow of the fluid to a side of the first divided thermal energy storage tank and a flow of the fluid to a side of the high temperature-side bypass flow path.

17. The thermal energy storage tank of claim 16, further comprising:
one or more low temperature-side bypass flow paths configured to bypass the second to m-th divided thermal energy storage tanks; and
one or more low temperature-side bypass valves configured to switch between a flow of the fluid to a side of the second to m-th divided thermal energy storage tanks and a flow of the fluid to a side of one or more the low temperature-side bypass flow paths.

18. The thermal energy storage tank of claim 15, wherein an incorporated amount of the first solid sensible heat storage material is set so that a thermocline created inside the thermal energy storage tank is only present in the first area at an end of a thermal dissipation operation.

19. The thermal energy storage tank of claim 15, wherein an incorporated amount of the first solid sensible heat storage material is set so that a temperature area that is not a thermocline created inside the thermal energy storage tank is not present in the first area at an end of a thermal dissipation operation.

20. The thermal energy storage tank of any one of claim 12, wherein
a cross-sectional area of a flow path in the first area
is the same as a cross-sectional area of a flow path of an n-th solid sensible heat storage material incorporated in an n-th area on an upstream side of the fluid during a thermal dissipation operation than the first area or
larger than the cross-sectional area of a flow path of the n-th solid sensible heat storage material.

21. The thermal energy storage tank of claim 14, wherein
a cross-sectional area of a flow path in the first area
is the same as a cross-sectional area of a flow path of an n-th solid sensible heat storage material incorporated in an n-th area on an upstream side of the fluid during a thermal dissipation operation than the first area or
larger than the cross-sectional area of a flow path of the n-th solid sensible heat storage material.

22. The thermal energy storage tank of claim 19, wherein
a cross-sectional area of a flow path in the first area
is the same as a cross-sectional area of a flow path of an n-th solid sensible heat storage material incorporated in an n-th area on an upstream side of the fluid during a thermal dissipation operation than the first area or
larger than the cross-sectional area of a flow path of the n-th solid sensible heat storage material.
